(19) United States
(12) Patent Application Publication
(10) Pub. No.: US 2025/0365292 A1
(43) Pub. Date: Nov. 27, 2025

(54) Managing Distributed Resources Using Projections, Hierarchical Projection Graphs, and Structured Queries

(71) Applicant: Steven Spungin, Marblehead, MA (US)

(72) Inventor: Steven Spungin, Marblehead, MA (US)

(21) Appl. No.: 19/296,514

(22) Filed: Aug. 11, 2025

Related U.S. Application Data
(63) Continuation-in-part of application No. 18/934,354, filed on Nov. 1, 2024.
(60) Provisional application No. 63/595,173, filed on Nov. 1, 2023.

(51) Int. Cl. H04L 9/40

(52) U.S. Cl. CPC H04L 63/105

(57) ABSTRACT

A tagspace system manages distributed resources. The tagspace system enables resources to be projected on (also referred to as “tagged to”) other resources. Such tagging enables resources to be organized using tags in a way that decouples such organization from the locations in which the resources are stored or derived, thereby overcoming problems associated with folder-based resource systems. Such tagging also overcomes limitations of convention label-based tagging, which does not enable the dimensions or hierarchy of tags that are enabled by embodiments of the present invention. Tags may be applied to resources stored in or accessed via multiple systems (e.g., multiple cloud-based file systems), thereby providing a unified way to view and otherwise interact with resources from such multiple systems. In addition, resources may be organized into hierarchical structures, referred to as “projection graphs,” which may be namespaced, versioned, and shared among users, thereby overcoming the typical fixed correspondence between individual users and the organization of their resources. Projection graphs allow for the propagation of attributes and events between graph nodes. Projection graphs may be queried using a structure parameter to obtain information and to apply transformations concerning their edges, vertices, properties, metadata, and content.

### CROSS-REFERENCE TO RELATED APPLICATIONS

This application is a continuation-in-part of U.S. patent application Ser. No. 18/934,354, filed on Nov. 1, 2024, entitled, “Staged Resource Querying,” which claims the benefit of U.S. Prov. Pat. App. No. 63/595,173, filed on Nov. 1, 2023, both of which are hereby incorporated by reference in their entirety.

### BACKGROUND

Resource management systems have become increasingly important as the volume and complexity of digital data continue to grow. Traditional file systems organize resources in hierarchical folder structures, which can be limiting when dealing with diverse types of data across multiple resource providers. These systems often struggle to provide flexible organization, efficient retrieval, and seamless collaboration capabilities.

One challenge in conventional resource management is the rigid coupling between resource organization and resource providers. This tight coupling makes it difficult to create logical groupings of resources that span different storage systems or cloud services. Users frequently encounter issues when trying to organize and access their data across various platforms and devices.

Another problem arises from the limitations of simple tagging systems. While tags allow for some flexibility in categorizing resources, they typically lack the ability to create rich, hierarchical relationships between tagged items. This constrains users' ability to build complex organizational structures that accurately reflect the relationships between their resources.

Collaboration and sharing present additional hurdles in existing resource management solutions. Many systems tie access permissions directly to folder structures or individual files, making it cumbersome to share specific subsets of resources or maintain different organizational views for different users. This can lead to inefficient workflows and security concerns when collaborating on projects or sharing data with external parties.

Version control is another area where traditional file systems often fall short. While some solutions offer basic versioning capabilities, they frequently lack the granularity and flexibility needed to manage complex versioning scenarios, especially when dealing with resources and resource associations that may exist across multiple resource providers or services.

Furthermore, querying and retrieving resources based on complex criteria can be challenging in conventional systems. Users often struggle to efficiently locate and aggregate resources that match specific attributes or relationships, particularly when those resources are distributed across different resource providers or organizational structures.

Existing approaches have attempted to address some of these issues through various means. Some systems have implemented more advanced tagging capabilities or metadata-based organization. Others have focused on improving search functionality or developing cloud-based storage solutions. However, these approaches often address only a subset of the challenges and may introduce new complexities or limitations in the process.

Despite these efforts, there remains a persistent need for a comprehensive resource management solution that can provide flexible organization, efficient retrieval, seamless collaboration, and powerful querying capabilities across diverse resource types and resource providers. Addressing these challenges could significantly improve productivity and data management for individuals and organizations dealing with large volumes of digital resources.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments of the present invention provide a flexible and powerful system for organizing, managing, and sharing digital resources across multiple resource providers and users. The invention introduces a projection-based approach that decouples the logical organization of resources from their resource providers, allowing for more versatile and efficient resource management. Embodiments of the invention may implement an Everything-as-a-Resource (EAR) approach that represents a fundamental paradigm shift from type-specific handling to universal resource management, enabling any system entity to participate in projection relationships and organizational structures.

In some implementations, the system utilizes resource identifiers (RIDs) to create associations between resources independently of their resource providers. These associations, called projections, enable users to organize and access resources in ways that transcend traditional folder-based hierarchies. The EAR approach ensures that projections can span across different resource providers, users, and namespaces, providing a unified view of distributed resources while treating files, applications, users, devices, organizational structures, content streams, derived resources, and partial resources with consistent properties and capabilities.

According to certain aspects, the invention implements a sophisticated permission model through “grants” that allows fine-grained control over how resources and their associations are shared and accessed. This model supports multiple security modes, including private, public, and custom configurations. The permission system enables complex scenarios, such as requesting access to resources and their associations, and allows for granular control over viewing, projecting, and managing resources and their associations within different namespaces and versions.

Various embodiments of the present invention introduce the concept of projection states, which can include private, floating, not-visible, and attached states. These states determine how projections appear to different users based on their permissions and the current security model. This approach allows for nuanced control over resource visibility and accessibility.

In some embodiments, the system supports versioning of projections, allowing users to create and manage multiple versions of resource associations. This feature enables more sophisticated organization and collaboration scenarios, where different versions of projections can be managed independently.

The invention also introduces concepts such as orphan flags for handling non-existent resources, trigger conditions for automating actions based on system changes, and expiration conditions for grants and projections. These features contribute to a more robust and dynamic resource management system.

Embodiments of the present invention aim to overcome limitations of traditional file systems and folder-based organization methods, providing a more flexible, collaborative, and powerful way to manage digital resources in increasingly complex and distributed computing environments. This approach allows for:
Decoupling of logical organization from physical storage, enabling more flexible resource management
Spanning and associating resources across different resource providers, users, namespaces, and versions
Implementing sophisticated permission models with fine-grained access control
Supporting complex collaboration scenarios with features like ask conditions and projection states
Enabling multiple valid organizational paths for the same resources
Providing a unified system for managing diverse resource types beyond traditional files and folders
Access and manage the relationships between resources when resources are unavailable or restricted
Configure and query the relationships between resources through universal resource abstraction.
Version the relationships between resources separately from the versions of resource content, supporting the EAR approach's unified treatment of diverse resource types
Allowing associating resources within namespaces regardless of permission to project within the namespace.
Allows for the resolution of when multiple associations and permissions overlap.

By addressing these challenges, the invention offers a comprehensive solution for modern digital resource management, catering to the needs of diverse users and complex organizational structures in distributed and collaborative environments.

Other features and advantages of various aspects and embodiments of the present invention will become apparent from the following description and from the claims.

### BRIEF DESCRIPTION OF THE DRAWINGS

FIG. 1 illustrates a flowchart for managing projections and projection states according to one embodiment of the present invention.

FIG. 2 depicts a flowchart for managing projections and projection states according to another embodiment of the present invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

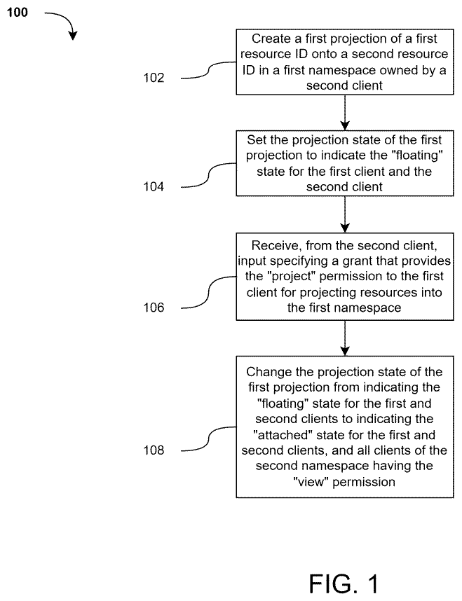

Referring to FIG. 1, a flowchart is shown of a method 100 for managing projections and projection states according to one embodiment of the present invention. Before describing the method 100 of claim 1 in detail, certain terms used herein will be defined and explained.

A security model in embodiments of the present invention may refer to a framework that governs how projections are visible and accessible to different clients within the system. The security model determines the default behavior for projection visibility and access control. Embodiments of the present invention may, for example, include support for any one or more of the following security models:
Private security model: In this model, clients may only view their own projections. The “private” parameters of projections default to an enabled value, ensuring that projections remain visible only to their projectors when the system is in a private state. This model provides a high level of isolation and privacy, which may be useful in scenarios where data segregation and confidentiality are paramount.
Public security model: When the system is in a public security model, the “private” parameters of projections may default to a disabled value. This model facilitates greater collaboration and sharing of resources across different clients, enabling easier discovery and access of shared resources within the system.
Custom security model: This model may allow for more granular control over projection visibility and access. In a custom security model, the system can be configured with preset rules that determine project, view, and manage permissions for each client, namespace, version, source, and target. This model offers the most flexibility, allowing system administrators or users to define specific rules that support complex organizational structures and collaboration scenarios.

Embodiments of the present invention allow for transitions between these security models. This flexibility may enable organizations to adapt their resource management approach based on changing needs or specific project requirements. In all security models, the system may use concepts such as projection states (e.g., private, floating, not-visible, and attached) to further refine how projections appear to different users based on their permissions and the current security model. This approach may allow for nuanced control over resource visibility and accessibility within each security model.

As used herein, a “projection” refers to an association between resource identifiers (IDs). A projection may be a contextual relationship between resource IDs that enables association, organization, cross-reference capabilities, and/or flexible resource management across multiple organizational contexts. A projection may, for example, be created independently of resource providers for those resource IDs. Projections support the flexible resource management approach of embodiments of the present invention by decoupling the logical organization of resources from their resource providers and resource providers. A projection includes a source resource ID and a target resource ID, creating a relationship that can span across different resource providers, users, and/or namespaces. Unlike traditional file system hierarchies where resources must exist within specific folders, projections enable resources to be organized in multiple ways simultaneously without requiring duplication or aliases. Projections can exist in various states—including private, floating, not-visible, and attached—which determine how they appear to different users based on their permissions and the current security model. Additionally, projections can be versioned, allowing users to create and manage multiple versions of resource associations independently. This projection-based approach enables sophisticated organization and collaboration scenarios where resources can be logically grouped regardless of their resource provider, while maintaining fine-grained control over visibility and access through the system's permission model.

The technical implementation of versioned projection relationships may involve data structures and algorithms for managing multiple concurrent organizational schemes. In some cases, the system may maintain version trees that track the relationships between different versions of projections, enabling efficient storage and retrieval of versioned organizational data.

Versioned projection relationships may support delta-based storage mechanisms, where only the differences between versions are stored rather than complete copies of each version. This approach may optimize storage efficiency while maintaining fast access to any version of a projection relationship. In some implementations, the system may use content-addressable storage techniques to deduplicate common elements across different versions.

The system may implement version resolution algorithms that determine which version of a projection relationship should be used in specific contexts. In some cases, version resolution may consider factors such as user permissions, namespace contexts, temporal constraints, or explicit version specifications provided by users or applications accessing the projection system.

Conflict resolution mechanisms may be employed when multiple versions of projection relationships overlap or contradict each other. In some implementations, the system may provide configurable policies for handling version conflicts, including priority-based resolution, user-mediated conflict resolution, or automatic merging strategies that combine compatible changes from different versions while flagging incompatible modifications for manual review.

Embodiments of the present invention may implement projection inheritance capabilities that enable organizational structures to inherit characteristics and relationships from other projections. In some cases, projection inheritance may allow complex organizational hierarchies to be built upon existing projection structures, creating layered organizational schemes that can evolve and adapt over time.

Projection inheritance may enable a projection to derive properties, relationships, and organizational context from one or more parent projections. In some implementations, when a projection inherits from another projection, the inheriting projection may automatically acquire the organizational relationships and structural characteristics of the parent projection while maintaining the ability to define additional unique relationships and properties.

In some cases, projection inheritance may support multiple inheritance patterns, where a single projection can inherit from multiple parent projections simultaneously. This capability may enable the creation of complex organizational structures that combine characteristics from different organizational schemes, allowing for sophisticated resource management scenarios that reflect real-world organizational complexity.

The inheritance relationships between projections may be versioned independently, allowing different versions of inheritance structures to exist simultaneously. In some implementations, changes to parent projections may propagate to inheriting projections according to configurable inheritance policies, enabling dynamic organizational structures that can adapt to changes in underlying projection relationships.

In some implementations, resource identifiers (RIDs) may be implemented as opaque identifiers that encapsulate resource identity information while hiding internal structural details from end users and client applications. The opaque nature of RIDs may provide abstraction that allows the system to manage complex resource relationships and metadata without exposing implementation-specific details to users. This opacity may enable the system to evolve its internal identifier structure and encoding mechanisms without affecting client applications or user workflows.

RIDs may be structured as self-contained, portable identifiers that encapsulate multiple types of information within a single identifier construct. In some cases, a RID may contain resource content references, provider-specific metadata, system configuration data, and resource state information within its internal structure. This self-contained approach may enable RIDs to carry all necessary information for resource access and management across different system contexts and storage environments without requiring external lookups or additional metadata retrieval operations.

The system may implement variable-length encoding schemes for RIDs to accommodate different types of resources and varying amounts of encapsulated data. In some implementations, RIDs may use compact encoding for simple resources with minimal metadata, while employing extended encoding formats for complex resources that require extensive configuration data or provider-specific information. The variable-length approach may optimize storage efficiency while maintaining the flexibility to represent diverse resource types and their associated metadata within the identifier structure.

RIDs may incorporate immutable resource state flags that provide persistent indicators of resource status and characteristics. These state flags may include resource availability indicators, access permission markers, version control flags, and provider connectivity status information. In some cases, the immutable nature of these flags may ensure that critical resource state information remains consistent across different system operations and cannot be inadvertently modified during resource manipulation or projection operations. The state flags may be embedded within the RID structure and may be accessible to the system for decision-making processes while remaining opaque to end users.

Embodiments of the present invention may support multi-source and multi-target projections that enable complex organizational operations through declarative syntax. In some cases, a single projection statement may affect multiple resources simultaneously, allowing users to create sophisticated resource relationships with minimal syntax complexity. Multi-source projections may allow multiple resource IDs to project onto a single target resource, while multi-target projections may enable a single source resource to project onto multiple target resources simultaneously.

In some implementations, multi-source projections may be expressed using array syntax where multiple source resource IDs are specified in a single projection statement. For example, a projection statement may specify [rid(1), rid(2), rid(3)] as sources projecting onto rid(4) as a target, creating three simultaneous projection relationships. The system may process these multi-source projections atomically, ensuring that all specified source-to-target relationships are established or none are established, maintaining consistency across the projection graph.

Multi-target projections may similarly use array syntax to specify multiple target resources for a single source. In some cases, a projection statement may specify rid(1) as a source projecting onto [rid(2), rid(3), rid(4)] as targets, creating multiple outgoing projection relationships from the single source resource. The system may handle these multi-target projections by creating individual projection entities for each source-target pair while maintaining the logical grouping established by the original multi-target statement.

Many-to-many projections may combine multi-source and multi-target capabilities, allowing multiple sources to project onto multiple targets within a single projection statement. In some implementations, a projection statement may specify [rid(1), rid(2)] as sources projecting onto [rid(3), rid(4)] as targets, creating a Cartesian product of projection relationships where each source projects onto each target. This approach may enable complex organizational structures to be established through concise declarative syntax.

The encapsulation of resource content, provider-specific metadata, and system configuration data within RIDs may enable seamless resource access across heterogeneous storage environments. In some implementations, a RID may contain sufficient information to locate, authenticate with, and retrieve resources from their respective providers without requiring separate configuration files or external metadata repositories. This encapsulation approach may support the system's ability to maintain resource relationships and enable projection operations even when resources are distributed across multiple storage systems with different access protocols, authentication mechanisms, and metadata formats.

A “resource,” as that term is used herein, may refer to any of a variety of computer-implemented resources, such as data, an application, an endpoint, or an organizational element within the system architecture that can be referenced, projected, and/or organized within the projection framework. The Everything-as-a-Resource (EAR) approach ensures that resources encompass the broadest possible range of system entities, enabling universal resource management across diverse types and providers. For example, resources may include digital content provided by cloud storage services, user-generated data from social media platforms, communication records from messaging applications, multimedia files from streaming services, and structured information from database management systems. Resources may include documents from file hosting services (e.g., Dropbox, Google Drive), images from photo sharing platforms (e.g., Flickr, Instagram), videos from video hosting websites (e.g., YouTube, Vimeo), contacts from address book applications, and calendar events from scheduling software. Resources may include PDF files from document management systems, email messages from email service providers, code repositories from version control systems (e.g., Git), spreadsheets from collaborative office suites, and audio recordings from podcast hosting platforms. Resources may be generated by their resource provider. Resources may contain dynamic content derived from other resources, supporting the creation and management of derived resources as first-class entities. Resource providers may include, for example, cloud storage services (e.g., Amazon S3, Google Cloud Storage, Microsoft Azure Blob Storage), content delivery networks (CDNs), social media platforms (e.g., Facebook, Twitter, Linkedin), enterprise content management systems, and collaborative workspace platforms (e.g., Slack, Microsoft Teams). As other examples, resource providers may include database management systems (e.g., MySQL, PostgreSQL, MongoDB), version control systems (e.g., Git, Subversion), email servers and services, file synchronization and sharing services (e.g., Dropbox, Box), content management systems (e.g., WordPress, Drupal), virtual machine providers, and web hosting services. As yet additional examples, resource providers may include local file systems, network-attached storage (NAS) devices, storage area networks (SANs), individual hard drives or solid-state drives, memory management systems, embedded systems with data storage capabilities, and Internet of Things (IoT) devices that generate or store data. These are merely examples of resources and resource providers, and do not constitute limitations of the present inventions.

Embodiments of the present invention may implement an Everything-as-a-Resource (EAR) approach that represents a fundamental paradigm shift in resource management. The EAR approach may extend beyond traditional file and folder paradigms to provide universal resource abstraction, enabling any system entity to participate in projection relationships and organizational structures. This unified approach may treat files, applications, users, devices, organizational structures, content streams, derived resources, and partial resources as manageable resources with consistent properties and capabilities.

The EAR approach may eliminate the artificial boundaries that traditionally separate different types of system entities. In conventional systems, files may be managed differently from applications, users may be handled separately from devices, and organizational structures may operate independently from content. The EAR approach may unify these disparate elements under a single resource management framework, allowing them to be projected, organized, versioned, and shared using the same underlying mechanisms.

This universal treatment may enable sophisticated organizational scenarios that were previously impossible or impractical. For example, a user may project an application onto a document, creating an association that indicates the preferred tool for processing that content. Similarly, a device may be projected into an organizational structure, establishing the device's role within a particular workflow or team configuration. The EAR approach may support these diverse relationship types through the same projection-based infrastructure, providing consistency and flexibility across all resource interactions.

As used herein, a “resource provider” may refer to any system, service, or entity that manages, stores, or generates resources accessible within the projection-based resource management system. Resource providers may operate at various levels of abstraction, from high-level cloud services to low-level hardware components.

The EAR approach may extend to content streams, treating live data feeds, network streams, and real-time content as projectable resources with full organizational capabilities. Content streams may include video streams from surveillance systems, sensor data from IoT devices, social media feeds, financial market data, and any other continuously updating information sources. These streams may be projected onto other resources, organized within namespaces, and managed through the same permission models and versioning capabilities as traditional static resources.

Content streams may support temporal projections, allowing users to create associations with specific time ranges or streaming segments. For example, a particular segment of a video stream may be projected onto a project milestone, creating a temporal bookmark that can be shared and organized like any other resource. The system may maintain these temporal associations even as the underlying stream continues to evolve, providing persistent access to specific content portions within dynamic data sources.

Derived resources represent another aspect of the EAR approach, encompassing generated content, summaries, transformations, and computed results that are managed as first-class resources independent of their source materials. These may include automatically generated document summaries, translated versions of content, extracted metadata, computed analytics results, and any other content that is derived from existing resources through processing or transformation.

The system may treat derived resources with the same capabilities as original resources, allowing them to be projected, versioned, shared, and organized independently. This independence may enable sophisticated workflows where derived content can evolve separately from its sources, be combined with other resources, and serve as the basis for additional derivations. For example, a translated document may be projected into multiple organizational contexts, versioned independently of the original, and used as the source for further derived resources such as summaries or extracted key points.

The EAR approach may extend to partial resources, treating resource fragments, selections, bookmarks, and content portions as complete resources with full projection capabilities. Partial resources may include individual paragraphs within documents, specific time ranges within audio or video content, selected regions within images, particular records within databases, or any other subset of a larger resource that can be meaningfully referenced and manipulated.

These partial resources may be projected, organized, and shared independently of their parent resources, enabling fine-grained content management and organization. For example, a specific paragraph within a research paper may be projected into multiple topic-based organizational structures, allowing it to participate in different contextual relationships while maintaining its connection to the original document. The system may maintain referential integrity between partial resources and their sources while allowing independent lifecycle management, versioning, and access control.

Partial resources may support dynamic boundaries, where the specific content included in the partial resource can be adjusted over time without breaking existing projections or organizational relationships. This flexibility may enable adaptive content management where resource boundaries can evolve based on changing requirements or improved understanding of content relationships.

In some implementations, resource providers may offer APIs or interfaces that allow embodiments of the present invention to interact with and manage resources. These interfaces may enable operations such as creating, reading, updating, deleting, and processing resources, as well as querying metadata and managing access permissions.

Resource providers may vary in their capabilities, performance characteristics, and security features. The projection-based system may abstract these differences, allowing users to interact with resources from diverse providers through a unified interface. This abstraction may enable the system to support a wide range of resource types and storage paradigms, from traditional file-based systems to more complex distributed and cloud-native architectures.

In some cases, resource providers may implement caching mechanisms, replication strategies, or other optimizations to improve resource access and availability. Embodiments of the present invention may leverage these provider-specific features while maintaining a consistent user experience across different resource types and resource providers.

In embodiments of the present invention, these diverse resources and their corresponding providers may be seamlessly integrated into a unified resource management system through the Everything-as-a-Resource (EAR) approach. The projection-based approach may allow users to create logical associations between resources across different providers, enabling flexible organization and access that transcends traditional folder-based hierarchies and type-specific management approaches. For example, a user may create a projection that links a PDF file stored in a document management system with related email messages from an email service provider, a live video stream from a surveillance system, and derived summary content generated from the original document, creating a logical grouping of diverse resource types regardless of their providers or provider boundaries.

The system may utilize resource identifiers (RIDs) to create these associations independently of the resource providers, allowing for a more versatile and efficient resource management approach that embodies the EAR approach. This may enable users to organize and access resources in ways that were not previously possible with traditional file systems or content management solutions, treating all system entities as manageable resources with consistent properties and capabilities.

Furthermore, the sophisticated permission model implemented through “grants” may allow for fine-grained control over how these diverse resources are shared and accessed across different providers and users. The EAR approach ensures that permission models apply consistently across all resource types, whether they are traditional files, live content streams, derived resources, or partial resource fragments. This may support complex collaboration scenarios while maintaining security and privacy controls appropriate for each resource type and provider, enabling universal resource management regardless of the underlying resource characteristics or origins.

By supporting such a wide range of resources and providers through the Everything-as-a-Resource approach, embodiments of the present invention may offer a comprehensive solution for modern digital resource management, addressing the needs of diverse users and complex organizational structures in increasingly distributed and collaborative computing environments. The EAR approach may eliminate artificial boundaries between different types of system entities, enabling unified management of files, applications, users, devices, content streams, derived resources, and partial resources through consistent projection-based mechanisms.

Embodiments of the present invention may implement a cyclic projection architecture that fundamentally transforms how resources are organized and accessed within distributed systems. This architecture may eliminate the traditional dependency on root folders and hierarchical tree structures, instead enabling resources to organize themselves through association-based relationships that can form cycles and horizontal connections.

In some cases, the cyclic projection architecture may allow resources to be organized in cycles where any resource within the cycle can serve as either a root or a leaf node, depending on the traversal path. This approach may overcome limitations of traditional folder-based systems where resources must exist within fixed hierarchical positions. For example, a document resource may be projected onto a project resource, which may in turn be projected onto a team resource, and the team resource may be projected back onto the original document resource, creating a cycle where each resource can be accessed from any other resource in the cycle.

The elimination of traditional root folders may be achieved through the system's ability to calculate multiple valid projection paths for the same set of resources. In some implementations, when resources are organized in cycles, the system may dynamically determine appropriate starting points for navigation based on user context, permissions, or query parameters, rather than requiring a fixed root directory structure. This may enable more flexible and intuitive resource organization that reflects the actual relationships between resources rather than artificial hierarchical constraints.

Returning to FIG. 1, the method 100 creates a first projection (FIG. 1, operation 102). In some cases, the first projection may be created in response to input from a first client. The first projection may be a first projection of a first resource ID onto a second resource ID in a first namespace owned by a second client.

The cyclic projection architecture may support auto-organization capabilities where resources automatically group themselves based on detected relationship patterns. In some cases, the system may analyze projection relationships to identify common association patterns and automatically create organizational structures that reflect these relationships. For example, resources that are frequently projected together or that share common projection targets may be automatically grouped into association-based collections.

Auto-organization by relationship patterns may involve the system monitoring projection creation and modification activities to identify emerging organizational structures. In some implementations, the system may detect when multiple resources consistently project to the same target resources or when resources form recurring projection chains, and may automatically suggest or create organizational groupings based on these patterns. This approach may enable the system to adapt its organizational structure to match actual usage patterns rather than requiring users to manually maintain hierarchical folder structures.

In some cases, the auto-organization process may utilize machine learning algorithms or pattern recognition techniques to identify meaningful relationship patterns within the projection graph. The system may analyze factors such as projection frequency, user access patterns, temporal relationships between projection creation, and semantic relationships between resource content to determine optimal organizational groupings. These automatically detected patterns may then be used to create association-based organizational structures that evolve dynamically as resource relationships change over time.

A namespace in embodiments of the present invention may refer to a virtual organizational container that provides a context for projections. A namespace may be specified in projection references, enabling resources to participate in multiple organizational contexts simultaneously without physical duplication or movement. Namespaces may serve as a mechanism for grouping related projections, allowing for better organization and management of resources across different users, teams, or projects within the system. By utilizing namespaces, embodiments of the invention may provide a more flexible and powerful approach to resource management, allowing for sophisticated organization and collaboration scenarios while maintaining fine-grained control over resource visibility and accessibility.

Association-based grouping in the cyclic projection architecture may enable resources to be organized according to their projection relationships rather than their storage locations or hierarchical positions. In some implementations, resources that share projection relationships may automatically become part of the same organizational context, regardless of their physical storage locations or traditional folder assignments. This approach may create dynamic organizational structures that reflect the actual working relationships between resources.

The association-based grouping mechanism may operate by analyzing the projection graph to identify clusters of resources that are highly interconnected through projection relationships. In some cases, resources that project to each other, share common projection targets, or participate in projection chains may be grouped together into association-based collections. These collections may provide alternative organizational views that complement or replace traditional folder-based organization, allowing users to navigate resources based on their actual relationships rather than artificial hierarchical structures.

In some implementations, association-based grouping may support multiple simultaneous organizational contexts for the same resources. A single resource may participate in multiple association-based groups depending on its various projection relationships, enabling users to access the same resource through different organizational pathways. This multi-dimensional organization may provide more flexible and intuitive resource access patterns that better match how users actually work with related resources in collaborative environments.

In the context of embodiments of the present invention, namespaces may play a significant role in:
Access control: The system may use namespaces to implement granular permission models, where access rights can be defined at the namespace level. This may enable administrators to control which users or clients can view, project, or manage resources within specific namespaces.
Collaboration: Namespaces may facilitate collaboration by providing shared spaces where multiple users can work on related resources. Different teams or departments within an organization may have their own namespaces, allowing for efficient resource sharing and management.
Versioning: The invention may support versioning of projections within namespaces, allowing users to create and manage multiple versions of resource associations independently.
Flexibility in resource organization: Namespaces may allow resources to be organized and accessed in multiple ways simultaneously, transcending the limitations of traditional folder-based hierarchies.
Cross-provider integration: Namespaces may help in creating logical associations between resources from different providers, enabling users to group and manage resources across various storage systems or cloud services.

Associated groups of resources may be created through horizontal projections in the cyclic projection architecture, enabling resources to be connected with or without forming cycles. In some cases, resources may be grouped together as equals within an organizational context through projection relationships that create peer-to-peer associations rather than hierarchical parent-child structures. This approach may support more flexible organizational models that better reflect collaborative working relationships.

Groups of resources may be associated through horizontal projections with or without forming cycles. For example, a group may be formed through projections such as chocolate→vanilla, vanilla→strawberry, mint→strawberry, and strawberry→chocolate, creating an associated group where resources are interconnected through various projection paths. In some implementations, the presence or absence of cycles may not change the net group members, as the fundamental associations between resources remain consistent regardless of whether the projection relationships form closed loops.

The absence of a designated parent resource within associated groups may provide significant advantages for group management and expansion. In some cases, new resources may be added to an associated group by creating a projection relationship with any existing member of the group, rather than requiring knowledge of or access to a specific root or parent resource. This approach may enable more flexible and distributed group management, where any member of the group can serve as an entry point for adding new resources or establishing new associations. For example, documents from different departments, applications from different providers, and data from different storage systems may be brought together through horizontal projections to create a unified working context for a specific project or task, without requiring the resources to be moved or copied from their original locations.

The cyclic projection architecture may provide “folder by association” capabilities where resources become part of the same organizational context through any association relationship, independent of traditional hierarchical folder structures. In some implementations, resources that are projected to each other or that share projection relationships may automatically appear together in organizational views, creating dynamic folder-like groupings based on actual resource relationships rather than predetermined folder hierarchies.

Folder by association capabilities may enable the system to present resources in organizational contexts that are determined by their projection relationships rather than their storage locations. In some cases, when a user accesses a resource, the system may automatically present other resources that are associated with it through projection relationships, creating a dynamic folder-like view that includes all related resources regardless of where they are physically stored or how they are organized in traditional folder structures.

In some implementations, the folder by association mechanism may support multiple levels of association, where resources can be grouped not only based on direct projection relationships but also based on indirect relationships through intermediate resources. For example, if resource A is projected to resource B, and resource B is projected to resource C, then resources A and C may appear in the same association-based folder context even though they do not have a direct projection relationship. This transitive association capability may enable the creation of rich organizational contexts that capture complex relationship patterns within the resource graph.

The folder by association approach may also support temporal and contextual factors in determining organizational groupings. In some cases, resources that are accessed together frequently, modified within similar time periods, or used in similar contexts may be grouped together in association-based folders, even if they do not have explicit projection relationships. This contextual association capability may enable the system to create organizational structures that reflect actual usage patterns and working relationships, providing more intuitive and useful resource organization for users.

One aspect of projections in embodiments of the present invention is that a projection may have, for each of one or more clients, a corresponding projection state. Each such projection state may indicate whether the projection is in a private state, a floating state, a not-visible state, or an attached state for the corresponding client. For example, the first projection that is created in step 102 may have, for each of a plurality of clients, a corresponding projection state that indicates whether the first projection is in a private state, a floating state, a not-visible state, or an attached state for that client.

The first projection may create an association between the first resource ID and the second resource ID independently of resource providers of the first resource ID and the second resource ID. For example, the resource provider of the first resource ID may differ from the resource provider of the second resource ID, and yet the first projection may create an association between the first resource ID and the second resource ID, in a way that is independent of the difference in resource providers between the first resource ID and the second resource ID.

Any projection may have a “private” parameter, which may have a value of enabled or disabled. For purposes of example, assume that the first projection that is created in step 102 has an enabled value.

In the method of FIG. 1, the first projection has, for each of a plurality of clients, a corresponding projection state that indicates whether the projection is in a “private state,” a “floating state,” a “not-visible state,” or an “attached state” for that client. This means that when the first projection is created in step 102, the system establishes these state relationships for each client. The projection state determines how the projection appears to different clients within the system, with each state providing different visibility and interaction capabilities.

The first projection creates an association between the first resource ID and the second resource ID independently of resource providers of the first resource ID and the second resource ID. This independence from resource providers is a key feature that allows projections to create logical relationships between resources regardless of where or how they are physically stored or managed. The projection states serve as a mechanism for controlling visibility and access to these resource associations. When a projection is in a particular state for a client, that state determines whether and how the client can view and interact with the projection.

The first projection has a “private” parameter with a disabled value. This parameter setting affects how the projection states are determined for different clients. By providing different projection states, the system offers users a flexible way to create personal organizational schemes or work-in-progress associations without affecting the broader resource management landscape. Users may experiment with different ways of linking resources or preparing collaborative structures before making them visible to others. This capability enhances the overall usability and adaptability of the resource management system across various use cases and organizational needs.

The projection states can include “floating,” “attached,” “private,” and “not-visible” states, each providing different levels of visibility and interaction capabilities to clients. For example, a projection may be in a “floating” state for some clients, an “attached” state for others, and a “not-visible” state for yet others, depending on the permissions and settings applicable to each client. This granular control over projection visibility enables sophisticated collaboration scenarios while maintaining appropriate access controls.

### Projection Lifecycle States

Embodiments of the present invention may implement projection lifecycle states that provide a structured workflow for resource organization and collaboration. These states may represent different phases in the lifecycle of a projection, each serving specific functional purposes and enabling different types of user interactions with projected resources.

A private projection may be visible exclusively to its creator, enabling confidential resource organization, staging workflows, and personal augmentation of shared resources without affecting other users. In some implementations, private projections may allow users to experiment with resource relationships, prepare collaborative structures, and organize resources for personal use before deciding whether to share them with others. This private state may support scenarios where users need to work with sensitive information, develop organizational schemes without external visibility, or augment shared resources with personal annotations or connections that remain confidential.

A floating projection may represent an intermediate state where the projection exists but awaits attachment approval to the target namespace. This state may provide controlled collaboration workflows with explicit consent mechanisms, allowing namespace owners to review and approve projection requests before they become fully integrated. In some cases, floating projections may enable a staged approach to collaboration, where projections are visible to creators and namespace owners but not yet accessible to other users with view permissions. This intermediate state may facilitate approval processes, permission negotiations, and controlled resource sharing scenarios.

An attached projection may represent a fully integrated projection that is visible to the projector, namespace owners, and users with explicit view permissions. This state may represent the active collaborative state of resource sharing, where projections are fully operational within the namespace and accessible according to the established permission model. In some implementations, attached projections may enable full collaborative functionality, including cross-referencing capabilities, organizational integration, and multi-user access to projected resource relationships.

The progression between these states may constitute a projection lifecycle that supports various workflow scenarios. In some cases, projections may begin in a private state for confidential development, transition to a floating state for approval processes, and ultimately reach an attached state for active collaboration. This lifecycle approach may enable users to manage the visibility and accessibility of resource relationships in a controlled manner, supporting both individual work and collaborative scenarios while maintaining appropriate security and permission controls throughout the process.

Referring to FIG. 1, the next step involves setting the projection state of the first projection to indicate the “floating” state for the first client and the second client (step 104). Step 104 may be performed in response to determining that the first client is not marked private and lacks “project” permission for the first projection in the namespace.

The first projection may be visible to the first client as a “floating” projection. This means the first client can see the projection, but it is not yet fully integrated or attached within the namespace. Similarly, the first projection may be visible to all owner clients of the first namespace, including the second client, as a “floating” projection. This allows namespace owners to see the projection in its preliminary state. For other clients who have “view” permission for the projection, the first projection is not visible and appears in a “not-visible” state. This may prevent clients with only view permissions from seeing projections that are not yet fully established or approved. Likewise, for clients who do not have “view” permission for the projection, the first projection may remain in a “not-visible” state. This ensures that clients without appropriate permissions cannot see the projection at all. This configuration of projection states may allow for a staged approach to projection visibility, where the projection is initially visible only to its creator and namespace owners before potentially becoming more widely accessible.

In step 106 of FIG. 1, the method 100 receives input from the second client that specifies a grant providing the “project” permission to the first client for projecting resources into the first namespace. This step may allow for dynamic adjustment of client capabilities within the namespace.

The grant received in this step may serve as a mechanism for the second client, who may be an owner or administrator of the first namespace, to extend additional permissions to the first client. By granting the “project” permission, the second client may enable the first client to create and manage projections within the specified namespace.

In step 108 of FIG. 1, the method 100 changes the projection state of the first projection from indicating the “floating” state for the first and second clients to indicating the “attached” state for the first and second clients, and all clients of the second namespace having the “view” permission. This transition may occur in response to receiving the input specifying the grant that provides the “project” permission to the first client.

When the projection state changes to “attached”, the first projection may become visible to the first client as an attached projection. Similarly, the first projection may become visible to all owner clients of the first namespace, including the second client, as an “attached” projection. Additionally, the first projection may become visible to other clients having “view” permission for the projection as an “attached” projection or as an “attached-view” projection. The first projection may not be visible to other clients not having “view” permission for the projection, as a “not-visible” projection.

This change in projection state may signify that the projection is now fully integrated into the namespace structure and accessible to a wider range of clients. The transition from “floating” to “attached” state may indicate that the projection has been approved or validated within the system, potentially allowing for more extensive interaction and collaboration around the associated resources.

By updating the projection state for multiple clients simultaneously, the system may efficiently propagate visibility changes across the namespace. This may enable a coordinated shift in how the projection appears to various clients, potentially facilitating smoother collaboration and resource sharing within the namespace.

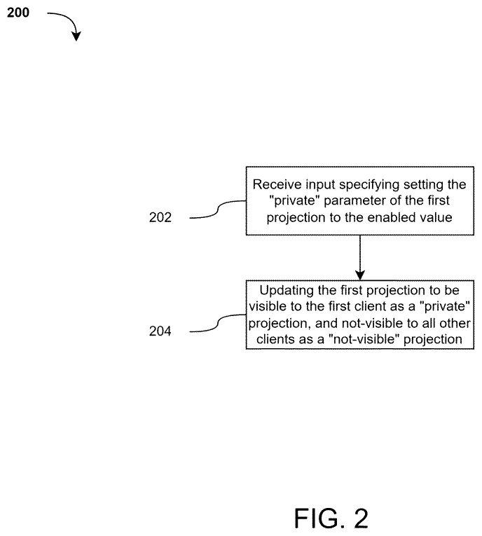

The method 100 of FIG. 1 may include additional steps not shown in FIG. 1 for ease of illustration. For example, referring to FIG. 2, a flowchart is shown of a method 200 that may be performed after the method 100 of FIG. 1. The method 200 may include receiving input specifying setting the “private” parameter of the first projection to the enabled value (step 202). This step allows a user to change the visibility of the projection by making it private, which restricts access to only the projection creator while hiding it from all other users in the system, with the “private” state being conveyed to the projector to make them aware that the projection is not visible to other clients.

In response to receiving the input specifying the first projection to have a private parameter with an “enabled” value, the method 200 may update the first projection to be visible to the first client as a “private” projection, and not-visible to all other clients as a “not-visible” projection (step 204). This step ensures that when a projection is marked as private, it becomes exclusively visible to its creator while being completely hidden from all other users in the system, thereby providing a mechanism for users to maintain personal organizational structures that remain private.

When the first projection is updated to have a private parameter with an “enabled” value in step 204, several consequences may occur:
The first projection may become visible to the first client as a “private” projection. This means that the first client, who created or owns the projection, may retain exclusive visibility and access to the projection. The private state may allow the first client to work on or organize resources without interference or visibility from other users in the system.
The first projection may become not visible to all owner clients of the first namespace, including the second client, as a “not-visible” projection. This may effectively hide the projection from namespace owners who would typically have broad access rights within their namespace. By setting the projection to a private state, even those with administrative privileges over the namespace may be prevented from seeing or interacting with the projection.
The first projection may become not visible to other clients having “view” permission for the projection, as a “not-visible” projection. This may override any previously granted view permissions, ensuring that clients who may have had the ability to see the projection in its non-private state can no longer access or view it. This behavior may help maintain the strict privacy of the projection regardless of existing permission structures.
The first projection may become not visible to other clients not having “view” permission for the projection, as a “not-visible” projection. While these clients may not have had visibility to the projection previously, this state ensures continued non-visibility, maintaining consistency across all non-owner clients in the system.

These consequences may collectively ensure that the projection enters a state of strict privacy, visible only to its creator or owner. This functionality may allow users to create and manage personal organizational structures or work-in-progress projections without concern for unintended visibility or access by other users in the system, regardless of their permission levels or roles. One benefit of embodiments of the invention is that the creator or owner may project into any namespace regardless of granted permissions, and decide whether or not this projection has the potential to be visible to others.

After step 106 of the method 100 of FIG. 1, the system may receive input specifying the revocation of the “project” permission from the first client for the first projection. This step may occur in cases where the first client was previously granted the “project” permission for the first projection, but that permission is now being withdrawn. The revocation of the “project” permission may change the projection state from “attached” to “floating”, but the first client will still be able to see the projection. This step may allow for dynamic adjustment of client permissions, enabling system administrators or authorized users to modify access rights as needed based on changing project requirements or organizational policies.

In response to receiving the input specifying the grant that revokes the “project” permission from the first client for the first projection, the system may change the projection state of the first projection to the “floating” state for the first client, second client, and owner clients of the first namespace for the first projection. Simultaneously, the system changes the projection state for other clients having and not having the “view” permission to the “not-visible” state. This state transition effectively makes the first projection visible to the first client as a “floating” projection, and visible to all owner clients of the first namespace, including the second client, as a “floating” projection. However, the first projection becomes not visible to other clients having “view” permission for the projection, as a “not-visible” projection, and remains not visible to other clients not having “view” permission for the projection, as a “not-visible” projection. This comprehensive state adjustment ensures that when project permissions are revoked, the projection's visibility is appropriately restricted across different client types while maintaining visibility for the projection creator and namespace owners.

When the projection state changes to “floating” for some clients and “not-visible” for others, it may create a tiered visibility system for the projection:
The first client, who may have created or initially managed the projection, can still see it as a “floating” projection. This means they retain visibility and some level of access, but the projection may not be fully integrated or active within the namespace.
Similarly, all owner clients of the first namespace, including the second client, can see the projection as “floating”. This allows namespace owners and administrators to maintain awareness of projections in this intermediate state, potentially for review or approval purposes.
However, other clients who previously had “view” permission for the projection can no longer see it. The projection becomes “not-visible” to them, effectively revoking their ability to interact with or even be aware of the projection's existence. This may be useful for temporarily restricting access during updates or reviews.
Lastly, clients who never had “view” permission for the projection continue to have no visibility. The projection remains in a “not-visible” state for them, maintaining their lack of access.

This configuration allows for a controlled visibility approach, where the projection is only visible to its creator and namespace owners, while being hidden from all other users regardless of their previous permissions. This may facilitate processes such as review, modification, or approval of projections before they become more widely accessible within the system.

After step 106, the system may receive input that grants “view” permission to a third client for the first projection. This third client previously did not have “view” permission for this projection. By granting “view” permission, the system allows the third client to see and access the projection, expanding the group of users who can interact with it. This step may enable broader collaboration or information sharing within the system by selectively extending visibility to additional clients. The ability to dynamically grant permissions to specific clients provides flexibility in managing access control and allows for fine-tuned adjustments to projection visibility as project needs or team structures evolve. Next, the system may, in response to receiving the input specifying the grant that revokes the “view” permission from the third client for the first projection, maintain the projection state of the first projection with the “attached” state for the first and second clients, and change the projection state of the third client having the “view” permission to the “not-visible” state.

As a result, several consequences occur:
the first projection is visible to the first client as an “attached” projection;
the first projection is visible to all owner clients of the first namespace including the second client, as an “attached” projection;
the first projection is visible to the third client and other clients previously having “view” permission for the projection, as an “attached” projection; and
the first projection is not visible to other clients not having “view” permission for the projection, as a “not-visible” projection.

The system may receive input indicating that the “view” permission previously granted to the third client for the first projection should be revoked. This action may be initiated by an authorized user or administrator who wishes to restrict the third client's access to the projection.

In response to receiving input that revokes the “view” permission for the third client, the system may update the projection states accordingly. For the first and second clients, the projection state of the first projection may remain in the “attached” state, allowing them to continue accessing and interacting with the projection as before. However, for the third client whose “view” permission has been revoked, the system may change the projection state to “not-visible.” This change may effectively hide the projection from the third client, preventing them from seeing or interacting with it any further. The system may implement these state changes simultaneously, ensuring that the visibility adjustments take effect immediately across all affected clients. This approach may allow for granular control over projection access, enabling administrators to quickly modify visibility settings for specific users without disrupting the access of other authorized clients.

Following the revocation of “view” permission from the third client for the first projection, several consequences may occur:
The first projection may remain visible to the first client as an “attached” projection. This means the first client, who may have created or initially managed the projection, retains full visibility and access to the projection in its integrated state within the namespace.
Similarly, the first projection may continue to be visible to all owner clients of the first namespace, including the second client, as an “attached” projection. This allows namespace owners and administrators to maintain their existing level of access and oversight over the projection, ensuring they can continue to manage and monitor resources within their namespace effectively.
For other clients who previously had “view” permission for the projection, the projection may remain visible as an “attached” projection. This suggests that the revocation of the third client's permission does not affect the visibility status of other clients who retained their “view” permissions. These clients may continue to see and interact with the projection as before, maintaining collaborative access where appropriate.
However, the first projection may become not visible to the third client, whose “view” permission was revoked, as well as to other clients who do not have “view” permission for the projection. For these clients, the projection may appear in a “not-visible” state. This change in visibility status effectively removes the projection from the third client's accessible resources, while maintaining the existing lack of visibility for clients who never had view permissions.

This configuration may allow for selective control over projection visibility, where access can be granted or revoked on a client-by-client basis without affecting the visibility status of other users in the system. Such granular control may facilitate dynamic team structures, project-based access management, and the ability to adjust resource visibility as collaboration needs evolve over time.

### Claim 5

In embodiments of the present invention, a “grant” may refer to a mechanism for specifying and managing permissions within the resource management system. Grants may allow for fine-grained control over how projections and resources are accessed, viewed, and manipulated by different clients within various namespaces. By utilizing grants, the system may provide a flexible and powerful way to implement complex access control scenarios that go beyond traditional file system permissions.

The method 100 of FIG. 1 may include a variety of additional steps related to creating and activating a grant, as well as resolving projection states based on the permissions specified in the grant. In some cases, the method may begin with receiving input from the second client to create a grant for the first namespace. The second client may be an owner of the first namespace, which may give the second client the authority to create and manage grants within that namespace.

When creating the grant, the second client may specify at least one permission selected from “project” permission and “view” permission. The project permission allows the system to change the projection state from floating to attached (if not private), while the view permission may allow a client to see and access projections without necessarily being able to modify them.

These permissions may be mutually exclusive, providing granular control over client actions within the namespace.

In addition to specifying permissions, the grant may also include a scope. The scope may indicate the first namespace and at least one grantee. The grantee may be a client or a group of clients to whom the specified permissions will apply within the defined scope. By allowing for the specification of both permissions and scope, the grant system may enable highly customized access control configurations.

After the grant has been created, the method may involve activating the grant in the computer system. The activation process may make the grant effective, allowing it to influence how projections are accessed and managed within the specified scope.

In response to activating the grant, the system may perform certain actions for each client specified as a grantee in the scope. These actions may include identifying at least one permission applicable to that client based on the grant. This step may involve evaluating the permissions specified in the grant and determining how they apply to each grantee within the defined scope.

Following the identification of applicable permissions, the system may resolve projection states for that client in accordance with the at least one permission applicable to that client. This resolution process may involve updating the projection states (such as private, floating, not-visible, or attached) for various projections within the scope of the grant, based on the newly applied permissions. The resolution of projection states may ensure that clients can only access and interact with projections in ways that are consistent with their granted permissions.

The method 100 of FIG. 1 may include other steps that expand upon the grant creation process, allowing for more complex and flexible scope specifications. In this case, the second client, who may be an owner of at least one namespace including the first namespace, may create a grant with a broader range of scope options.

The grant created in this method may specify at least one permission, similar to the grant described above. However, the scope of this grant may be more expansive and may comprise at least one of the following options:
Any version of projections
Any namespace owned by the second client.
A specific resource ID across any namespace or version owned by the second client
A specific combination of namespace and version
A specific projector client independent of namespace or version
A specific target resource ID independent of namespace or version
A specific source resource ID independent of namespace or version
Metadata and content of a source or target resource.

These scope options may allow for highly flexible and granular control over how permissions are applied across different resources, namespaces, and versions within the system. For example, a grant could be created that applies to all versions of projections within a specific namespace, or to a particular resource ID regardless of which namespace or version it appears in. Scope options may be expressed in specific or general terms.

After creating this more complex grant, the method may involve activating the grant in the computer system, similar to the process described above. In response to activating the grant, the system may perform actions for each client specified as a grantee in the scope.

For each grantee, the system may identify at least one permission applicable to that client based on the grant and the scope. This identification process may take into account the more complex scope specifications, ensuring that permissions are correctly applied across the specified resources, namespaces, or versions.

Finally, the system may resolve projection states for that client in accordance with the at least one permission applicable to that client. This resolution process may update projection states across the entire scope of the grant, which may span multiple namespaces, versions, or specific resources depending on the scope specification.

By allowing for such flexible and powerful grant creation and activation processes, embodiments of the present invention may provide a sophisticated access control system that can adapt to complex organizational structures and collaboration scenarios. This approach may enable fine-grained management of resource visibility and accessibility across diverse storage systems and cloud services, addressing limitations of traditional file systems and content management solutions.

Embodiments of the present invention may support simultaneous multiple versions of organizational schemes, enabling users to maintain and work with different versions of projection relationships concurrently. In some cases, multiple versions of the same organizational structure may exist within the system, each representing different states, configurations, or evolutionary stages of resource organization.

The system may maintain multiple versions of projection graphs simultaneously, allowing users to compare different organizational approaches, experiment with alternative structures, or maintain historical versions of organizational schemes. In some implementations, each version may be independently accessible and modifiable, enabling parallel development of organizational structures without interference between different versioning branches.

Simultaneous versioning may enable collaborative scenarios where different users or teams can work on different versions of the same organizational structure concurrently. In some cases, the system may provide mechanisms for merging changes between versions, resolving conflicts when multiple versions are combined, or maintaining separate version branches for different purposes or user groups.

Version management may include capabilities for creating version snapshots, branching organizational structures into multiple development paths, and maintaining version history for projection relationships. In some implementations, the system may support version tagging, allowing users to mark specific versions with descriptive labels or metadata that facilitate version identification and management across complex organizational scenarios.

In embodiments of the present invention, grants and projections may be subject to various conditions, permissions, and states that govern their behavior and visibility within the system. These mechanisms allow for fine-grained control over resource access and organization, enabling complex collaboration scenarios while maintaining security and flexibility.

Conditions associated with grants may include time-based conditions, usage-based conditions, content-based conditions, user role-based conditions, and attribute-based conditions. These conditions may determine when and how permissions are applied, as well as when grants become invalid or require modification.

Time-based conditions may allow for the specification of temporal constraints on grant permissions. In some cases, a grant may only be valid during specific hours of the day or on certain days of the week. For example, a grant may enable permissions for a grantee during a specified time period, such as business hours or a project duration. The system may evaluate these time-based conditions and dynamically adjust the effectiveness of the grant accordingly.

Usage-based conditions may involve permissions that depend on how frequently or in what manner resources are accessed or modified. For instance, a grant may allow access only for a specific number of times, or may expire after a certain threshold of interactions has been reached. This enables resource owners to control not just who has access, but how much access they have over time.

Expiration conditions may define circumstances under which a grant becomes invalid or requires modification. In some cases, a grant may be automatically disabled or removed when certain criteria are no longer met. For example, a grant may expire after a set period of inactivity or when a project reaches completion. When expiration conditions are met, the system may modify the state of the grant, which may involve disabling the grant, removing it from the system, or requiring manual re-enablement.

Content-based conditions may restrict permissions based on the actual content or properties of the resources involved. For example, grants may be configured to apply only to resources containing specific keywords, metadata values, or file types. This allows for automated permission management based on the nature of the resources themselves rather than just their identifiers or locations.

User role-based conditions enable permissions to be tied to organizational hierarchies or job functions. These conditions may dynamically adjust access rights based on a user's role within an organization or project team, automatically granting or revoking permissions as roles change. This approach aligns resource access with organizational structures and responsibilities.

Attribute-based conditions may involve permissions based on specific characteristics of users, resources, or system states. In some cases, access rights may be determined by attributes such as security clearance levels, geographical location, device type, or resource metadata. The system may identify projections with attributes matching the specified conditions and enable the relevant permissions for those projections. This approach allows for flexible and context-aware access control.

When conditions are satisfied, the system may perform several actions to maintain consistency and notify affected parties. These actions may include:
Identifying projections affected by the modified grant state
Updating projection states for the identified projections
Maintaining relationships between the identified projections and their associated resources
Notifying affected clients of changes to the grant and projection states

In some cases, the system may update projection states to a floating state when a grant is disabled due to condition expiration. This ensures that projections previously attached based on the grant are appropriately reclassified within the system.

The system may also handle resource availability conditions. In some cases, if a resource referenced by a grant becomes unavailable, the grant may be disabled. This may trigger a process of identifying projections affected by the disabled grant and changing their states based on the new circumstances.

Permissions specified in grants may include project permission, view permission, and in some cases, admin permission. The admin permission may enable clients within a scope to modify grants for a namespace. The admin permission is mutually exclusive of the view and project permissions, meaning that a client can be granted admin capabilities without necessarily having view or project permissions.

One feature of the permission system in embodiments of the present invention may be the concept of mutual exclusivity. Permissions specified in a grant may be mutually exclusive, meaning that granting one type of permission does not automatically confer other types of permissions. For example:
Granting project permission may not automatically grant view permission
Granting view permission may not automatically grant project permission
Granting admin permission may not automatically grant project or view permissions

This mutual exclusivity allows for precise control over user capabilities within the system, enabling administrators to tailor access rights to specific needs and roles.

When resolving projection states based on permissions, the system may follow specific rules, such as any one or more of the following. For example:
Projections may be set to an attached state when project permission is granted
Projections may be maintained in a floating state when project permission is not granted
Clients with view permission may be allowed to resolve only attached projections

These rules ensure that projection visibility aligns with the permissions granted to each client, maintaining the integrity of the access control system.

The interaction between conditions, permissions, and states creates a dynamic and flexible environment for managing the access and organization of resource associations. As conditions are evaluated and permissions are applied, the system may continuously update projection states to reflect the current access rights and visibility for each client. This approach allows for sophisticated collaboration scenarios while maintaining fine-grained control over the access and organization or resource associations across diverse resource providers and namespaces.

A grant may specify a condition set that includes at least one condition for applying the permission(s) associated with the grant. These conditions may encompass various types, such as any one or more of the following: a time-based condition, a usage-based condition, a content-based condition, a user role-based condition, or an attribute-based condition.

The method may further include determining that at least one condition is satisfied and, in response to determining that the at least one condition is satisfied: identifying at least one projection affected by the satisfied condition; and updating a projection state of the at least one projection based on the at least one permission.

In response to determining that the at least one condition is satisfied: the method may determine that the at least one condition is a time-based condition; and, during a specified time period: enable the at least one permission for the at least one grantee; and resolve projection states based on the enabled permission.

In response to determining that the at least one condition is satisfied: the method may determine that the at least one condition is an attribute-based condition; identify at least one projection that projects a resource, wherein the resource has attributes matching the attribute-based condition; enable the at least one permission for the identified projections; and resolve projection states for the identified projections.

The grant may further specify at least one expiration condition that, when satisfied, results in at least one of: disabling the grant; or removing the grant from the computer system.

The method may further include: determining that the at least one expiration condition is satisfied; in response to determining that the at least one expiration condition is satisfied: modifying a state of the grant; identifying at least one projection affected by the modified grant state; updating projection states for the identified projections; maintaining relationships between the identified projections and their associated resources; and notifying affected clients of changes to the grant and projection states. Modifying the state of the grant may include at least one of: disabling the grant, removing the grant, or requiring manual re-enablement of the grant. Updating projection states may include transitioning between at least two of: private state, floating state, attached state, and not-visible state.

The method may further comprise: determining that the at least one expiration condition is satisfied; in response to determining that the at least one expiration condition is satisfied: disabling the grant; identifying at least one projection affected by the disabled grant; updating projection states for the identified projections to floating state; and notifying affected clients of the projection state changes.

The may further include: determining that the at least one expiration condition is satisfied; in response to determining that the at least one expiration condition is satisfied: removing the grant from the computer system; identifying at least one projection that was attached based on the removed grant; changing the identified projections from a current state to a new state based on removing the grant; and notifying the at least one grantee and owners of the first namespace of the state changes.

The method may further include: determining that the at least one expiration condition comprises a resource availability condition; in response to determining that a resource referenced by the grant becomes unavailable: disabling the grant; identifying projections affected by the disabled grant; changing the identified projections from a current state to a new state based on disabling the grant; and maintaining relationships between the identified projections and their associated resources.

As the above explanation makes clear, grants in this system are powerful mechanisms for controlling access and permissions to projections and resources. They allow for fine-grained and dynamic control over how projections are visible and accessible to different clients within the system.

The condition set associated with a grant provides flexibility in applying permissions. For example, time-based conditions may allow access only during specific hours or days, enabling temporary or scheduled permissions. Usage-based conditions may limit access based on the number of times a resource has been accessed or modified. Content-based conditions may restrict permissions based on the type or properties of the resources involved. User role-based conditions enable permissions to be tied to organizational hierarchies or job functions. Attribute-based conditions offer even more granular control, allowing permissions to be based on specific metadata or tags associated with resources or projections.

When conditions are satisfied, the system may dynamically update projection states. This may involve changing projections from floating to attached state, or vice versa, depending on the permissions granted. The system's ability to identify affected projections and update their states accordingly ensures that access controls are consistently enforced across the entire resource graph.

The concept of expiration conditions adds another layer of dynamism to the permission system. Grants may be automatically disabled or removed based on various criteria, such as time limits or changes in resource availability. This feature is particularly useful for implementing temporary access or ensuring that permissions are automatically revoked when they are no longer needed or valid.

The system's handling of expired or disabled grants demonstrates its robustness in maintaining consistency. When a grant expires or is disabled, the system may not only update the grant's state but also identify all affected projections, update their states, maintain relationships between projections and resources, and notify relevant clients of the changes. This comprehensive approach ensures that the removal or disabling of a grant doesn't lead to orphaned projections or inconsistent states within the system.

Resolving projection states may include: setting projections to attached state when project permission is granted, maintaining projections in floating state when project permission is not granted, maintaining projections in private state when the private flag is determined, and allowing clients with view permission to see only attached projections. The permissions specified in the grant may be mutually exclusive, such that granting project permission does not automatically grant view permission, and granting view permission does not automatically grant project permission.

The at least one permission may further include “admin” permission. The first client may have been granted “admin” permission for the first namespace. The “admin” permission may enable managing grants for the first namespace.

The permissions specified in the grant may be mutually exclusive, such that: granting “admin” permission does not automatically grant project permission or view permission, granting “project” permission does not automatically grant admin permission or view permission, and granting “view” permission does not automatically grant admin permission or project permission.

The method may further include creating a projection condition for the first projection. This projection condition may specify criteria for enabling and disabling the first projection. The method may then determine whether the projection condition indicates that the first projection should be disabled. In response to determining that the first projection should be disabled, the method may remove the first projection from enumerable projections. The first projection may remain removed from enumerable projections until the projection condition indicates the first projection should be enabled. This approach allows for dynamic control over the visibility and accessibility of projections based on specified conditions, enabling flexible management of projection states within the system.

The method may further include determining that the projection condition indicates that the first projection should be enabled. In response to determining that the first projection should be enabled, the method may add the first projection to enumerable projections. The first projection may remain added to enumerable projections until the projection condition indicates the first projection should be disabled. This approach allows for dynamic control over the visibility and accessibility of projections based on specified conditions, enabling flexible management of projection states within the system. The ability to add and remove projections from enumerable projections based on projection conditions may provide a mechanism for temporarily hiding or revealing projections without permanently deleting them.

The method may further include creating a projection expiration condition for the first projection. The system may determine whether this expiration condition indicates that the first projection should expire. If it is determined that the first projection should expire, the method may perform several actions. These actions may include disabling the projection if it is already enabled, recalculating projection states, and notifying clients of any state changes. Additionally, the method may remove the first projection from available projections and notify affected clients of this removal. This approach allows for automatic management of projection lifecycles, ensuring that projections can be systematically expired and removed when certain conditions are met, while keeping relevant clients informed of these changes.

The method may further include specifying that the projection expiration condition comprises at least one of several types of conditions. These condition types may include a time-based condition, a usage-based condition, a content-based condition, a user role-based condition, or an attribute-based condition. This approach allows for flexible and diverse criteria to be used in determining when a projection should expire, enabling the system to automatically manage projection lifecycles based on various factors such as time limits, usage patterns, content characteristics, user roles, or specific attributes associated with the projection or its related resources.

The method may further include creating a trigger condition for the first projection. This trigger condition may specify criteria for detecting a change in projection state relative to a client, and may also specify an action to be executed when the criteria are satisfied. The method may then detect a change in projection state of the first projection and determine whether the detected state change satisfies the criteria specified by the trigger condition. In response to determining that the criteria are satisfied, the method may execute the specified action. This action may include at least one of: remapping a source or target of the first projection, deleting one or more resources related to the first projection, notifying one or more clients affected by the state change, or updating attributes of the first projection. Additionally, the method may trigger at least one event based on the projection state change. This approach allows for automated responses to changes in projection states, enabling dynamic management of projections and associated resources based on predefined conditions and actions.

The method may further include specifying that the trigger condition defines criteria for detecting transitions between different projection states. These transitions may include changes between floating state and attached state, private state and attached state, or attached state and floating state. This approach allows the system to monitor and respond to specific state changes in projections, enabling more granular control over how the system reacts to evolving projection statuses. By defining these transition-specific trigger conditions, the method may provide a mechanism for executing targeted actions or notifications when projections undergo particular state changes, enhancing the system's ability to manage and maintain the integrity of projection relationships dynamically.

The method may further include creating a trigger condition for the first projection. This trigger condition may specify criteria for detecting changes to registered projections, grants, or other system entities in the computer system. The trigger condition may also specify an action to be executed when the criteria are satisfied. The method may detect a change to the registered projections, grants, or other system entities and determine whether the detected change satisfies the criteria specified by the trigger condition. In response to determining that the criteria are satisfied, the method may execute the specified action and trigger at least one event based on the detected change. This approach allows for automated responses to changes in various system components, enabling dynamic management of projections and associated resources based on predefined conditions and actions. The system may monitor and react to changes across different aspects of the resource management environment, providing a flexible mechanism for maintaining consistency and executing relevant actions when specific changes occur.

The method may further include detecting changes to various system components as part of the trigger condition. These detectable changes may include creating, modifying, or deleting projections and grants. The method may also detect changes in the orphan state of resource IDs, including those referenced by grants or projections. Additionally, the system may monitor for changes in projection states, resource availability, registered clients, and client permissions. This change detection approach allows the system to respond dynamically to a wide range of modifications within the resource management environment, enabling automated actions and maintaining consistency across interconnected components.

The method may further include creating a trigger condition that specifies criteria for detecting changes to a resource's metadata, content, or lifecycle state, as determined by the resource provider associated with the resource. The trigger condition may also specify an action to be executed when the criteria are satisfied. The method may then detect a change to the resource's metadata, content, or lifecycle state and determine whether this detected change satisfies the criteria specified by the trigger condition. In response to determining that the criteria are satisfied, the method may execute the specified action. This approach allows the system to monitor and respond to changes in resource characteristics that are managed by resource providers, enabling automated actions based on evolving resource states or properties. By defining these resource-specific trigger conditions, the method may provide a mechanism for maintaining consistency and executing relevant actions when resources undergo particular changes, enhancing the system's ability to dynamically manage resources and their relationships within the environment.

The method may further include setting an invert property to enabled on the grant. The system may then determine whether the condition set for applying the at least one permission is satisfied. If the condition set is satisfied and the invert property is enabled, the method may evaluate the permission specified in the grant, identify projections within the grant's scope, deny the evaluated permission to the grantee for the identified projections, and update projection states based on the denied permission. Conversely, if the condition set is not satisfied and the invert property is enabled, the method may evaluate the permission specified in the grant, identify projections within the grant's scope, permit the evaluated permission to the grantee for the identified projections, and update projection states based on the permitted permission. This approach allows for inverting the typical behavior of permission grants based on specified conditions, providing a mechanism for more complex and flexible permission management within the system.

The method may introduce an orphan flag to handle cases where referenced entities no longer exist. This feature allows the system to maintain integrity and track the status of resources even when they become unavailable or are deleted.

In some aspects, the method may include determining that an entity referenced by a particular resource ID does not exist. Upon making this determination, the system may set an orphan flag for the particular resource ID to indicate resource non-existence. This approach enables the system to clearly mark and manage resources that have lost their associated entities.

The method may determine the non-existence of an entity through various means. In some cases, the system may receive a notification from a resource provider indicating that the entity referenced by the particular resource ID no longer exists. This allows for external systems or providers to inform the projection graph system about changes in resource availability.

The particular resource ID that becomes orphaned may be the first resource ID in some instances. In such cases, the method may involve determining that a resource referenced by the first resource ID does not exist, leading to the orphan flag being set for that resource ID.

Similarly, the particular resource ID may be the second resource ID in other cases. The method may then determine that a resource referenced by the second resource ID does not exist, resulting in the orphan flag being set for that resource ID.

These features collectively provide a mechanism for handling scenarios where referenced resources become unavailable or are deleted. By introducing the orphan flag, embodiments of the present invention may maintain awareness of resource status even when the actual entities no longer exist. This approach offers several benefits:
It allows the system to maintain integrity by tracking the status of all resources, including those that have become unavailable.
It provides a clear indication of resource non-existence, which can be useful for system maintenance, cleanup operations, and user notifications.
It enables the system to handle gracefully scenarios where resources referenced in projections or grants no longer exist, preventing errors or inconsistencies in the projection graph structure.
It allows for potential recovery or reconnection of orphaned resources if they become available again in the future.

Overall, the features described above enhance the robustness and reliability of the resource management system by providing a structured way to handle and track resources that have become disconnected from their original entities.

Embodiments of the present invention may implement an orphan state as a condition in which projections exist but reference missing, deleted, or uncreated source or target resources. This orphan state may represent a form of broken reference that requires user intervention to resolve while maintaining organizational integrity within the projection system.

In some implementations, projections may enter an orphan state when their referenced resources become unavailable due to various circumstances. Resources may be considered missing when they cannot be located by their resource providers, deleted when they have been intentionally removed from their storage systems, or uncreated when they represent planned or anticipated resources that have not yet been instantiated. The orphan state may allow projections to persist even when their underlying resource references are broken, preserving the logical organizational structure that users have created.

The orphan state may require user intervention to resolve broken references and restore full functionality to affected projections. Users may need to update projection targets to point to alternative resources, recreate missing resources, or remove projections that are no longer relevant. In some cases, the system may provide automated suggestions or tools to assist users in resolving orphan conditions, such as identifying similar resources that could serve as replacement targets or detecting when previously missing resources become available again.

Maintaining organizational integrity during orphan conditions may be a key aspect of the system's design. Even when projections reference broken resources, the system may preserve the projection relationships and their associated metadata, permissions, and organizational context. This approach may enable users to maintain their logical resource organization even when underlying resources are temporarily or permanently unavailable. The system may continue to enforce access controls, maintain projection states, and support querying operations for orphaned projections, allowing users to understand and manage their organizational structures regardless of resource availability.

In some implementations, the system may provide various mechanisms for detecting, reporting, and managing orphan states. Users may be notified when projections enter orphan states, and the system may provide tools for bulk operations on orphaned projections, such as updating multiple broken references simultaneously or cleaning up projections that reference permanently deleted resources. The orphan state management may integrate with the system's permission model, ensuring that only authorized users can resolve broken references or modify orphaned projections.

The method may further include handling scenarios where the particular resource ID refers to a namespace or client that no longer exists. In some cases, the particular resource ID may be associated with the first namespace. When determining that the entity referenced by this resource ID does not exist, the method may involve verifying that the first namespace itself no longer exists within the system.

Similarly, in other instances, the particular resource ID may be linked to the first client. In such cases, determining the non-existence of the referenced entity may involve confirming that the first client is no longer present or active in the system. This approach allows the method to handle orphaned resources not only at the individual resource level but also at higher organizational levels such as namespaces and clients. By extending orphan detection to these broader entities, the system may maintain consistency and integrity across different layers of the resource management structure, enabling more comprehensive tracking and handling of resources that have lost their contextual references.

The method may include additional steps in response to determining that an entity referenced by a particular resource ID does not exist. In some aspects, the system may maintain any existing projection states for the particular resource ID, even when the referenced entity is no longer available. These maintained projection states may include at least one of floating state, attached state, and private state. This approach allows the system to preserve the logical organization of resources even when the underlying entities become unavailable.

In some cases, the method may trigger at least one event to notify affected clients that an orphan flag has been set for the particular resource ID. This notification mechanism enables the system to inform relevant parties about changes in resource availability, allowing them to take appropriate actions or update their local representations of the resource structure.

The method may also handle scenarios where system entities or projections reference resource IDs that no longer exist. In such cases, the system may trigger events to notify affected clients about these inconsistencies. For system entities, the notification may indicate that the entity has at least one property referencing a non-existent resource ID. Similarly, for projections, the system may notify affected clients that the projection has at least one property referencing a resource ID that does not exist.

These features collectively enhance the system's ability to manage and communicate about orphaned resources, maintaining consistency and awareness across the distributed resource management environment. By providing detailed notifications about orphaned resources and references, the system enables clients to adapt to changes in resource availability and maintain accurate representations of the resource structure.

The method may include additional aspects related to the orphan flag for a particular resource ID. In some implementations, the orphan flag may exist as a state indicator that is independent of any projection states associated with the particular resource ID. This approach allows the system to maintain separate tracking of resource availability and projection relationships. The orphan flag may remain set until the entity referenced by the particular resource ID comes into existence, providing a persistent indicator of resource status. Additionally, the orphan flag may function as a computed attribute that indicates the non-existence of the entity referenced by the particular resource ID. This computed nature allows the system to dynamically reflect the current state of resource availability without requiring manual updates. By implementing the orphan flag with these characteristics, the system may provide a robust mechanism for tracking and managing resources that have become disconnected from their original entities, while maintaining flexibility in how this information is used and interpreted within the broader resource management framework.

The method may include functionality for enumerating orphaned resource IDs within the system. In some aspects, the system may receive a request to enumerate orphaned resource IDs. In response to this request, the method may involve identifying resource IDs that have orphan flags set to indicate resource non-existence. This identification process may include examining properties of system entities that reference resource IDs and determining which of these referenced resource IDs have orphan flags set. After this identification process, the system may provide an enumeration of the identified orphaned resource IDs.

The enumeration process may be further refined to identify specific types of system elements affected by orphaned resources. This may include identifying projections that have source or target resource IDs with orphan flags set, grants that reference resource IDs with orphan flags set, or other system entities that reference resource IDs with orphan flags set. The system may then provide an enumeration of these identified projections, grants, or system entities.

In some implementations, the enumeration may include additional metadata about each enumerated resource ID. This metadata may indicate whether each enumerated resource ID is referenced by a projection, whether it is referenced by a grant, and whether it is referenced by other system entities. By including this metadata, the system may enable the identification of broader system impacts caused by non-existent resources. This approach allows for a comprehensive understanding of how orphaned resources affect different aspects of the system, facilitating more effective management and maintenance of the resource structure.

The method may include features for creating and managing cyclic projections between multiple resource IDs. In some aspects, the system may project the second resource ID onto a third resource ID, and then project the third resource ID back onto the first resource ID. This series of projections, combined with the original projection from the first to the second resource ID, may create a cycle involving all three resource IDs. Within this cycle, any of the resource IDs may function as either a root or a leaf node.

The system may calculate multiple valid projection paths within this cycle. These paths may include a first path starting from the first resource ID and ending with the third, a second path starting from the second resource ID and ending with the first, and a third path starting from the third resource ID and ending with the second. Each of these calculated paths may represent a valid hierarchical view of the cycle. Importantly, multiple valid paths may exist simultaneously for the same set of projected resources, allowing for flexible and multi-dimensional resource organization.

In some implementations, the method may extend this concept to include additional projections and resource IDs. The system may create additional projections between the first, second, third, and a new fourth resource ID. This may involve projecting the first resource ID onto the third, the third onto the fourth, and the second onto the fourth.

The system may then calculate multiple projection paths within this expanded structure. For example, it may calculate a path starting from the first resource ID and ending with the fourth, passing through the second resource ID as an intermediate node. Another valid path may start from the first resource ID, end with the fourth, but pass through the third resource ID as an intermediate node. These multiple valid paths may exist simultaneously for the same set of projected resources.

In some cases, the method may further extend this structure by projecting the fourth resource ID back onto the first, creating a cycle that includes all four resource IDs. This cyclic structure may compound the number of valid paths that can be calculated within the system, further enhancing the flexibility of resource organization and access.

This approach to creating and managing cyclic projections and multiple valid paths may provide a powerful mechanism for representing complex relationships between resources. It may allow for diverse perspectives on resource organization, enabling users to navigate and understand resource relationships from various starting points and through different intermediary connections.

In some cases, the system may implement an “ask” mechanism as a feature for managing projection permissions. This mechanism may allow clients to request permission for creating projections in controlled environments, potentially enhancing the system's flexibility and security. Regardless of the outcome of the “ask” mechanism, the projector is not prohibited from creating the projection, or viewing the projection in some “non-attached” or “attached” state.

The ask mechanism may enable a more dynamic and interactive approach to permission management. Rather than relying solely on pre-defined grants, the system may allow clients to initiate requests for projection permissions as needed. This approach may be useful in scenarios where access needs change frequently or where strict control over resource projections is required.

By implementing the ask mechanism, the system may enhance security by ensuring that projections are only attached with explicit approval from namespace owners. This feature may enable fine-grained access control, allowing administrators to review and approve attachment requests on a case-by-case basis. The projector can choose whether projections are private, while the grantor can choose if the projections attach. Projections can still be created without explicit approval, but they will remain in a floating state unless and until approved by the grantor. For view permission, such granular control may help prevent unauthorized access. For project permission, it may prevent unauthorized propagation to clients with view permission and prevent unauthorized attached states, maintaining the integrity of the resource organization structure.

The ask mechanism may facilitate collaboration by providing a structured way for clients to request access to resources they need. It may create a transparent process for permission requests, approvals, and denials, which can be beneficial in team environments or when working across organizational boundaries. This feature may strike a balance between security and accessibility, potentially promoting efficient resource sharing while maintaining necessary access controls.

In some cases, the ask process may involve several stages: initialization, pending, and approval or denial.

The initialization stage may begin when a client creates a projection with an ask condition. The system may set the projection's state to “ask-init” for the requesting client, while setting it to “not-visible” for other clients. This state may indicate that an ask request has been initiated but not yet confirmed by the requesting client.

Upon confirmation from the requesting client, the projection's state may transition to “ask-pending”. In this state, the projection may become visible to namespace owners, allowing them to review and respond to the request. Other clients with view permissions may still see the projection as “not-visible” during this stage.

The approval or denial stage may occur when a namespace owner responds to the ask request. If approved, the projection's state may change to “attached” for all relevant clients. If denied, the state may become “ask-denied” for the requesting client and remain “not-visible” for others. In some cases, a “denial-once” response may return the projection to the “ask-init” state, allowing the client to potentially request again in the future.

Different types of clients may have distinct roles in the ask process. The requesting client initiates the ask request and may confirm or cancel it. Namespace owners may review, approve, or deny ask requests for their namespaces. Clients with view permissions may have limited visibility of projections during the ask process, depending on the current state.

The system may use grant tokens to track ask requests. These tokens may be generated when an ask request is initiated and may be used to authenticate and manage the request throughout its lifecycle. Grant tokens may allow the system to maintain state information about ongoing ask requests and ensure proper handling of approvals, denials, and cancellations.

In some cases, the method may begin with creating a grant having an “ask” condition for a first namespace. This grant may specify that certain projections require explicit approval before being fully established.

When a first client creates a second projection of a first resource onto a second resource in the first namespace, the system may initiate the ask request process. The system may generate a grant token for tracking this second projection's ask request, providing a unique identifier for the request throughout its lifecycle.

Upon creation of the second projection, the system may set its projection state for the first client to indicate an “ask-init” state. This state may signify that the ask request has been initiated but not yet confirmed. Simultaneously, the system may set the projection state to “not-visible” for any owner client of the second namespace and for any client having view permission for the second projection. This initial state configuration may ensure that the projection remains hidden from other clients until the request is confirmed and approved.

The system may then trigger at least one action in response to setting the second projection's state to “ask-init” for the first client. This action may include notifying the first client that confirmation is required or logging the initiation of the ask request.

When the system receives confirmation of the ask request from the first client, it may update the projection states accordingly. The second projection's state for the first client may be set to “ask-pending”, indicating that the request is now awaiting review. For any owner client of the second namespace, the state may also be set to “ask-pending”, making the request visible for review. The system may trigger another action in response to this state change, such as notifying namespace owners of the pending request.

The response stage may involve different scenarios based on the decision of the namespace owner. In the case of approval, the system may set the second projection's state to “attached” for the first client, any owner client of the first namespace, and any client having view permission. This state change may trigger actions such as notifying the first client of the approval or updating access controls.

In a denial scenario, the response may be either “denial-always” or “denial-once”. For a “denial-always” response, the system may set the projection state to “ask-denied” for the first client and “not-visible” for owner clients and clients with view permissions. This may trigger actions such as notifying the first client of the denial and logging the decision.

For a “denial-once” response, the system may reset the projection state to “ask-init” for the first client and “not-visible” for other clients. This allows the first client to potentially reinitiate the request in the future. The system may trigger actions to notify the first client of this temporary denial and the option to request again.

Throughout these stages, the system may update projection states differently for various types of clients. The requesting client (first client) may see states progress from “ask-init” to “ask-pending” to either “attached” or “ask-denied”. Namespace owners may see states change from “not-visible” to “ask-pending” to either “attached” or back to “not-visible”. Clients with view permissions may generally see the projection as “not-visible” until it becomes “attached”.

At each stage of state changes, the system may trigger specific actions. These actions may include sending notifications, updating logs, modifying access controls, or initiating other system processes relevant to the state change. These triggered actions may help maintain system integrity, keep relevant parties informed, and ensure proper handling of the ask request throughout its lifecycle.

In some cases, the ask mechanism may be extended or varied to accommodate different organizational needs. For example, the system may allow for multi-level approvals, where an ask request must be approved by multiple namespace owners or administrators before being granted. The system may also support conditional approvals, where the ask request is approved with certain limitations or expiration conditions.

The ask mechanism may be particularly beneficial in various use cases. In a collaborative research environment, it may allow researchers to request access to specific data sets or resources, ensuring that data owners can review and approve each request individually. In a corporate setting, the mechanism may facilitate controlled access to sensitive documents, allowing employees to request temporary access to confidential information when needed for specific projects. Another use case may involve software development teams, where developers may request access to certain code repositories or testing environments. The ask mechanism may provide a structured way to manage these requests, ensuring that access is granted only when necessary and with proper oversight.

The ask mechanism may integrate seamlessly with the broader permission and projection system. It may work in conjunction with existing grants and permissions, providing an additional layer of control when needed. For instance, a namespace owner may set up general permissions using standard grants, but implement the ask mechanism for particularly sensitive resources or operations.

In some cases, the ask mechanism may also interact with the system's versioning capabilities. An ask request may be associated with specific versions of resources or projections, allowing for fine-grained control over access to different iterations of a resource.

The system may also allow for the customization of ask request parameters. Namespace owners may be able to define specific criteria or questions that must be addressed in an ask request, ensuring that they have all necessary information to make an informed decision.

By integrating the ask mechanism with the existing permission and projection framework, the system may provide a comprehensive solution for managing access control in complex, collaborative environments. This integration may allow organizations to balance the need for security and control with the flexibility required for efficient collaboration and resource sharing.

A notification system within the ask mechanism may be used to manage projection permissions. This system ensures that relevant parties are informed about changes in projection states throughout the ask request process.

In some cases, the method may include notifying clients about various state changes of a projection during the ask process. These notifications may help keep all involved parties informed about the current status of an ask request.

When a projection's state is set to “ask-init” for the requesting client, the system may notify that client about this state change. This notification may serve to inform the client that their ask request has been initiated and may require further action or confirmation.

In some cases, when the projection's state transitions to “ask-pending”, the system may notify any owner client of the relevant namespace about this change. This notification may alert namespace owners that there is a pending ask request awaiting their review and decision.

The method may also include notifying both the requesting client and any owner client of the namespace when the projection's state is set to “attached”. This notification may inform all relevant parties that the ask request has been approved and the projection is now active.

In some cases, if the projection's state is set to “ask-denied”, the system may notify both the requesting client and any owner client of the namespace about this decision. This notification may ensure that all parties are aware that the ask request has been denied.

The method may also include notifying both the requesting client and any owner client of the namespace when the projection's state is set back to “ask-init”. This notification may occur in scenarios where a request is reset or allowed to be reinitiated.

These notification steps may be triggered automatically by the system in response to the corresponding state changes. By implementing this notification system, the ask mechanism may maintain transparency throughout the request process, keeping all relevant parties informed about the current status of projections and ask requests.

The ask mechanism in embodiments of the invention may include a process for handling cancellation of ask requests. This process may allow clients to withdraw their pending requests and resets the system state accordingly.

In some cases, while a projection's state is in the ask-pending state, the requesting client may submit a cancel-ask request. Upon receiving this cancellation request, the system may initiate a series of state changes and actions.

The system may set the projection's state for the requesting client back to the ask-init state. This change may allow the client to potentially reinitiate the request in the future if desired. For any owner client of the namespace and for any client with view permission for the projection, the system may set the projection state to not-visible. This state change may ensure that the cancelled request is no longer visible to other parties in the system.

In response to these state changes, the system may trigger at least one action. This action may include updating logs, sending notifications, or performing other system processes relevant to the cancellation of an ask request.

The system may also invalidate the grant token associated with the cancelled ask request. This invalidation may prevent any further use or processing of the cancelled request within the system.

Additionally, the system may notify any owner client of the namespace that the ask request has been cancelled by the requesting client. This notification may ensure that namespace owners are aware of the cancellation and can update their review processes accordingly.

These features of the ask mechanism provide a comprehensive approach to handling request cancellations, ensuring that all relevant parties are informed and that the system state is appropriately updated. This process may contribute to maintaining the integrity and efficiency of the permission management system within the invention.

The ask mechanism in embodiments of the invention may include features for storing and managing messages associated with ask requests and responses. This functionality enhances communication and record-keeping within the permission management system.

In some cases, the system may store a request message associated with the ask request from the requesting client. This stored message may contain details about the request, such as the resources being requested, the reason for the request, or any other relevant information provided by the client.

The system may also store response messages associated with various types of responses from the owner client. These responses may include approval responses, denial-always responses, or denial-once responses. By storing these messages, the system maintains a record of the decision-making process and the rationale behind each response.

The stored messages may be utilized in various ways throughout the ask request lifecycle. For example, when the system sets a projection's state to “ask-init” for the requesting client, it may trigger an action that sends the stored request message to any owner client of the relevant namespace. This allows the owner clients to review the details of the request as part of their decision-making process.

In cases where the projection's state is set to “attached” for the requesting client, indicating approval of the ask request, the system may trigger an action to send the stored response message to the requesting client. This ensures that the client receives detailed information about the approval.

Similarly, if the projection's state is set to “ask-denied” for the requesting client, the system may send the stored response message to the client. This message may contain information about why the request was denied and any potential next steps.

In scenarios where a denial-once response is received and the projection's state is reset to “ask-init” for the requesting client, the system may again send the stored response message to the client. This message may provide information about why the request was temporarily denied and instructions for reinitiating the request if desired.

By incorporating these message storage and communication features, the ask mechanism provides a comprehensive system for managing and tracking the entire lifecycle of ask requests. This approach ensures that all parties involved in the process have access to relevant information at each stage, promoting transparency and effective communication within the permission management system.

Some embodiments of the present invention extend the ask mechanism by introducing an automatic processing feature for ask requests. The system allows for both clients and namespace owners to enable automatic handling of ask requests, streamlining the permission request process.

In this embodiment, the method includes receiving indications from two different parties to enable automatic processing. First, the system receives an indication from the first client that enables automatic ask requests for projections. This allows the client to initiate ask requests without manual intervention for each projection they create. Second, the system receives an indication from an owner client of the first namespace that enables automatic processing of ask requests for that namespace. This allows the namespace owner to automatically handle incoming ask requests without manual review for each one.

When both of these automatic processing features are enabled, the system can handle ask requests more efficiently. Upon creating a second projection, if the system determines that both automatic ask requests and automatic processing are enabled, it takes two actions:
The system automatically sends the ask request without requiring explicit confirmation from the first client. This means the client does not need to manually confirm each ask request they initiate.
The system automatically sets the second projection's projection state for the first client to indicate the ask-pending state. This state change occurs without requiring explicit confirmation of the ask request from the client.

This automatic processing feature enhances the efficiency of the ask mechanism by reducing the need for manual interventions in the ask request process. It allows for a more streamlined workflow in scenarios where trust has been established between clients and namespace owners, or in situations where the volume of ask requests is high and manual processing would be impractical. The system maintains the structure and integrity of the ask mechanism while providing options for automation to suit different organizational needs and trust levels.

Some embodiments of the invention extend the ask mechanism to handle view permissions in addition to project permissions. The method introduces a second grant with an ask condition specifically for view permissions within a namespace.

When this second grant is created, the system initially sets the projection state to “not-visible” for any projections in the namespace that require this grant for view permission. This ensures that these projections are hidden from clients who have not yet been granted view access.

The process begins when a client requests view permission. Upon receiving this request, the system generates a unique grant token to track the view permission ask request. This token allows the system to manage and monitor the status of the request throughout its lifecycle.

The system then updates the projection states to reflect the pending nature of the request. For the requesting client, the projection state is set to “ask-pending” for any projections in the namespace that require the second grant for view permission. Similarly, the projection state for namespace owner clients is also set to “ask-pending”, alerting them to the pending request.

If an owner client approves the view permission request, the system updates the projection states accordingly. For the requesting client, the projection state is changed to “attached” for all relevant projections in the namespace. This allows the client to now view these projections. The projection state for owner clients is also set to “attached”, indicating that the request has been approved and the projections are now visible to the requesting client.

However, if the view permission request is denied, the system maintains the “not-visible” projection state for the requesting client. This ensures that the client cannot access the projections they requested to view.

This embodiment demonstrates how the ask mechanism can be applied to different types of permissions, providing fine-grained control over resource visibility and access within the system. It allows for a structured process of requesting, reviewing, and granting or denying view permissions, while maintaining appropriate visibility states throughout the process.

In some embodiments of the present invention, a method is provided for managing projection states and grants within a namespace system. This method involves setting projection states and handling grant expiration conditions.

The method begins by setting the projection state of a second projection to “attached” for multiple parties. Specifically, the second projection's state is set to “attached” for the first client, for any owner client of the first namespace, and for any client having view permission for the second projection. This ensures that the projection is visible and accessible to all relevant parties.

The method also includes a mechanism for handling grant expiration. When an expiration condition is satisfied, the system takes two actions. First, it disables the current grant. This may prevent further use of the permissions associated with that grant. Second, the system reverts to using a different grant, specifically one that has an ask condition, for determining the projection state of the second projection. This reversion may alter how the projection state is determined and potentially change the visibility or accessibility of the projection for various clients.

This approach allows for dynamic management of projection states and permissions, with the ability to automatically adjust access and visibility based on predefined expiration conditions. The method provides a flexible framework for controlling resource access and maintaining appropriate permissions over time within the namespace system.

In some embodiments of the present invention, a method for managing projections and permissions in a namespace system allows for multiple owner clients within a single namespace. This approach enhances the flexibility and collaborative potential of the system by enabling shared ownership and control over resources within a namespace.

The method specifically provides for at least one additional owner client to be associated with the first namespace, alongside the second client who is already established as an owner. This means that the namespace may have two or more clients with owner-level permissions and responsibilities. By allowing multiple owner clients, the system can accommodate various organizational structures and collaborative scenarios where shared control over a namespace is beneficial or necessary.

This multi-owner capability may enable more dynamic and distributed management of resources within the namespace. Each owner client may have equal rights to manage projections, grant permissions, and oversee the namespace's resources. This feature may be particularly useful in team environments, large organizations, or collaborative projects where multiple parties need high-level access and control over shared resources.

In some embodiments of the present invention, the system may provide various user interface features for displaying projection states and resource status information. These features may enhance the visibility and management of projections and resources within the system.

The system may include functionality to display the projection state of a projection for different types of clients via a user interface. For the client who created the projection, the system may show the current projection state through the user interface. Similarly, for the client who owns the namespace where the projection exists, the system may also display the projection state via the user interface. Additionally, for any other client who has view permission for the projection, the system may present the projection state through the user interface.

In cases where a resource referenced by a projection no longer exists, the system may display an orphan flag via the user interface. This orphan flag may indicate to users that a particular resource associated with a projection is no longer available, not yet available, or accessible.

The system may also include functionality to display an ask-requested flag through the user interface. This flag may indicate that a namespace owner needs to respond to an ask grant condition request, alerting the relevant parties that action is required in the permission management process.

Furthermore, the system may provide a feature to display an enumeration of resource IDs that have orphan flags set. This enumeration, presented via the user interface, may show a list of resources that are marked as non-existent within the system. This feature may help users identify and manage resources that are no longer available, not yet available, or have become disconnected from their original references.

The system may display, via a user interface, metadata indicating whether each enumerated resource ID is referenced by at least one of: a projection, a grant, or another system entity. This metadata display may provide users with important contextual information about how each resource is being used within the system, helping to identify resources that may be orphaned but still referenced by various system components. By visualizing these reference relationships, users may more effectively manage resource dependencies and understand the impact of potential changes to resources.

In some cases, the system may display, via a user interface, a count of overlapping projections for the first resource. These overlapping projections may comprise multiple valid organizational paths to access the first resource through different projections in any namespace, including the first namespace. This count may help users understand how extensively a particular resource is being used across different organizational structures, providing insight into the resource's importance and integration within the system. The visualization of overlapping projections may assist in identifying resources that serve as key nodes in multiple organizational hierarchies.

The system may also display, via a user interface, bidirectional projection path information for resources. This may include a first set of projection paths showing how other resources are projected onto the first resource, wherein each projection path in the first set may comprise a sequence of projections through which other resources are projected onto the first resource. Additionally, the system may display a second set of projection paths showing how the first resource is projected onto other resources, wherein each projection path in the second set may comprise a sequence of projections through which the first resource is projected onto other resources. This comprehensive view of incoming and outgoing projection paths may provide users with a complete understanding of a resource's position within the broader resource organization structure, facilitating more informed resource management decisions.

These user interface features may contribute to improved visibility and management of projections, permissions, and resource statuses within the system. By providing clear visual indicators of projection states, orphaned resources, pending requests, comprehensive lists of non-existent resources, reference metadata, overlapping projection counts, and bidirectional projection paths, the system may enable users to more effectively navigate and maintain the complex relationships between resources and permissions in the projection-based resource management environment.

In some embodiments of the present invention, a method for managing projections in a namespace system may include creating additional projections with version-specific associations. This approach allows for more granular control over resource relationships and enables version-specific management within the system.

The method may involve creating a third projection of the first resource onto the second resource within the first namespace. This third projection may have several key characteristics that distinguish it from other projections in the system.

Firstly, the third projection may specify a version qualifier. This version qualifier may indicate a specific version of the association that is represented by the third projection. By including a version qualifier, the system may allow for multiple versions of the same resource relationship to coexist within the namespace.

Secondly, the third projection may create an association between a specific version of the first resource and the second resource. This association may be established independently of the resource providers for both the first and second resources. This independence from resource providers may allow for flexible version management across different storage systems or platforms.

Lastly, the projection state of the third projection may be determined based on the version qualifier. This means that the visibility and accessibility of the projection within the system may depend on the specific version indicated by the qualifier. This feature may enable version-specific access control and management of resource relationships.

By incorporating these version-aware projections, the system may provide enhanced capabilities for managing complex resource relationships across different versions, while maintaining the flexibility and provider-independence of the projection-based approach.

In some embodiments of the present invention, a method for managing projections in a namespace system may include creating and activating grants with version-specific scopes. This approach allows for more granular control over resource relationships and enables version-specific management within the system.

The method may involve creating a grant for a namespace that specifies a scope with a version qualifier. This version qualifier may indicate any version of projections in the namespace, a specific version across any namespace owned by a particular client, or a specific combination of namespace and version. Upon activating the grant in the computer system, the method may identify permissions applicable to a client based on the version qualifier and resolve projection states for that client accordingly.

In some cases, the method may create a grant for a namespace with a scope that includes both a version qualifier and a target qualifier. The version qualifier may indicate a specific version of projections, while the target qualifier may specify a particular target resource. After activating this grant, the system may identify permissions applicable to a client based on both the version and target qualifiers, and then resolve projection states for that client based on the identified permissions.

Additionally, the method may allow for creating a grant with a scope that combines a version qualifier and a source qualifier. The version qualifier may again indicate a specific version of projections, while the source qualifier may specify a particular source resource. Upon activation of this grant, the system may identify permissions applicable to a client based on both the version and source qualifiers, and subsequently resolve projection states for that client in accordance with the identified permissions.

These approaches may provide enhanced flexibility in managing permissions and projection states within the namespace system. By incorporating version qualifiers along with target or source qualifiers, the system may offer fine-grained control over how projections are managed across different versions and resource relationships. This may enable more sophisticated version management and access control mechanisms within the projection-based resource management environment.

### Implementation Examples

Embodiments of the present invention may be implemented in any of a variety of computer-implemented forms. In some cases, embodiments of the present invention may be implemented as a standalone desktop application, a mobile application, a web-based application, or a distributed client-server system. The system may be integrated into existing software platforms, operating systems, or cloud services.

In some implementations, embodiments of the present invention may be provided as a software development kit (SDK) or application programming interface (API) that developers can incorporate into their own applications. The system may be implemented as a plugin or extension for existing file management or productivity software. For enterprise deployments, embodiments of the present invention may be implemented as a scalable cloud-based service that can handle large volumes of resources and users across multiple organizations. In some cases, the system may be deployed on-premises within an organization's private network infrastructure. Embodiments of the invention may also be implemented as part of a larger ecosystem of interconnected services and applications, enabling seamless integration with various resource providers, collaboration tools, and data analysis platforms.

The following sections provide more detailed descriptions of specific implementation approaches for the projection graph system, including user interfaces, backend architectures, and integration strategies. These descriptions are provided as examples and should not be considered limiting, as the invention may be implemented in many other forms not explicitly described herein.

In some cases, embodiments of the present invention may provide various user interfaces for creating and/or otherwise managing projections. One approach involves a graphical user interface that allows users to create projections by dragging and dropping resources onto other resources or namespaces. For example, a user may select a file icon representing a document and drag it onto a folder icon representing a namespace, which may create a projection of that document into the namespace. Another example would be dragging a file onto an image and allowing the user to specify a subject within the image to project the file onto.

Another method for creating projections involves a command-line interface where users can type commands to specify the source and target resources for a projection. In some implementations, this interface may support batch operations, allowing users to create multiple projections with a single command.

Embodiments of the present invention may provide a web-based interface for creating projections. This interface may present resources as clickable elements, where users can select a source resource and then choose a target resource or namespace from a dropdown menu or search field.

In some cases, the system may offer a context menu option for creating projections. Users may right-click on a resource and select “Project to . . . ” from a menu, which may open a dialog for choosing the target resource or namespace.

In some cases, the system may offer a context menu option or other means for executing additional actions, such as opening a dialog for managing orphan resources, displaying alternative path relationships, changing the reference node of a cyclic relationship, managing a trigger that involves a resource's lifecycle and associated projections, and showing alternative namespaces and versions.

Some implementations may include a dedicated “Create Projection” dialog or form where users can manually input or select the source and target resource identifiers, as well as specify any additional projection parameters.

Embodiments of the present invention may support programmatic creation of projections through an API. This may allow developers to integrate projection creation into their own applications or automate the process of organizing resources.

Embodiments of the present invention may support custom actions through an API. This may allow developers to create or respond to “ask” requests, manage orphan resources, and configure grants.

In certain implementations, the system may offer a natural language interface where users can create projections by typing or speaking commands in plain language, such as “project document A to document B.”

Some embodiments may provide a visual graph editor where users can create and manipulate projections by drawing connections between nodes representing resources and namespaces.

The system may support the creation of projections through file system operations in some cases. For example, moving a file into a special folder may automatically create a projection of that file into a corresponding namespace.

In some embodiments, the system may present a dialog to a user before, during, or after performing an action to inform them of side-effects of the action, such as what resources will be orphaned, if any resources will refer to orphans, or if any resources will have lifecycle changes due to the action. These results will take into consideration any active projections, grants, and triggers.

These various methods for creating projections may be used individually or in combination, providing users with flexible and intuitive ways to organize and associate resources within the system.

### Visualization Examples

Embodiments of the present invention may provide any of a variety of visualization methods for displaying projections and resource relationships. These visualizations may help users understand and interact with the relationships between resources across different namespaces and resource providers.

One approach involves displaying projections as interactive node-link diagrams. In this visualization, resources and namespaces may be represented as nodes, while projections may be shown as directed edges connecting these nodes. Users may be able to zoom, pan, and click on nodes to explore the projection structure. The system may use various node shapes or colors to distinguish between resource types, namespaces, versions, resource providers, and projection state.

Another visualization method presents projections as hierarchical tree structures. This view may show resources and namespaces as expandable tree nodes, with child nodes representing projected resources. Users may be able to collapse or expand branches of the tree to focus on specific parts of the projection hierarchy.

In some implementations, the system may offer a hybrid view that combines aspects of node-link diagrams and tree structures. This view may display the primary hierarchy as a tree while showing cross-hierarchy projections as additional links between nodes.

Embodiments of the present invention may provide a matrix visualization for projections. In this view, resources and namespaces may be arranged along the rows and columns of a matrix, with cells indicating projections between the corresponding row and column elements.

Some embodiments may include a radial or sunburst diagram to visualize projections. This circular layout may place the root namespace or resource at the center, with projected resources arranged in concentric rings around it. This visualization may be particularly effective for showing the depth and breadth of projection relationships.

The system may offer a timeline view in certain implementations, allowing users to see how projections and resource relationships have evolved over time. This may be useful for understanding the history of resource organization and tracking changes in project structures.

In some cases, the visualization may incorporate tag clouds or other text-based representations to show the most common tags or attributes associated with resources in a projection structure.

Embodiments of the present invention may provide 3D visualizations of projection structures, allowing users to navigate through a three-dimensional space representing the relationships between resources and namespaces.

The system may support customizable visualizations in some implementations, allowing users to define their own visual representations of projections based on specific attributes or metadata of the resources involved.

These visualization methods may be interactive, allowing users to filter, search, and manipulate the displayed projections directly within the visual interface. The system may also provide options to export these visualizations as images or interactive web-based representations for sharing or documentation purposes.

In some embodiments, details about the projection state may be shown to a user, allowing them to understand if a resource has projections to and from, if a cycle exists in any associated projections, if the resource is an orphan or references any orphan resources, if pending “ask” states apply to the resource, and the resolved states of projections within a namespace, such as “private”, “floating”, or “attached.

In some cases, embodiments of the present invention may provide users with notifications of projection events (e.g., in real-time), keeping them informed about changes in the system's state and resource relationships. These notifications may help users stay aware of important updates and collaborate more effectively.

The system may notify users when new projections are created. For example, when a first projection of a first resource ID onto a second resource ID in a first namespace is created, the system may send a notification to relevant users, such as the owner of the first namespace or users with view permissions for the involved resources.

Notifications may be triggered when projection states change. For instance, when a projection's state changes from “floating” to “attached”, the system may alert the projector and any clients with view permissions for that projection. Similarly, if a projection transitions to a “private” state, the system may notify the projector that the projection is now only visible to them.

Permission changes may generate notifications. When a grant is created or modified, such as when a second client provides “project” permission to a first client for projecting resources into a namespace, the system may notify both the grantor and the grantee of this change. This may help users stay informed about their evolving access rights within the system.

In some implementations, the system may send notifications when orphan flags are set for particular resource IDs. This may alert users when resources referenced by projections no longer exist or become unavailable, allowing them to take appropriate action.

The system may provide notifications for ask-related events. For example, when an ask request is initiated, pending, approved, or denied, the system may send notifications to the requesting client and relevant namespace owners. This may facilitate smoother communication and decision-making processes around permission requests.

Notifications may be delivered through various channels, such as in-app alerts, email notifications, or push notifications on mobile devices. Users may be able to customize their notification preferences, choosing which types of events they want to be notified about and how they receive these notifications.

In some cases, the system may provide a centralized notification center where users can view and manage all their notifications. This interface may allow users to filter notifications by type, mark them as read, or take direct actions in response to the notifications.

For time-sensitive events, the system may implement priority levels for notifications, ensuring that critical updates are prominently displayed and immediately brought to the user's attention.

These real-time notifications may help maintain system transparency and keep users informed about the dynamic state of projections, permissions, and resource relationships within the system.

In some cases, embodiments of the present invention may utilize various backend implementations to efficiently store and/or query projections. These implementations may be designed to handle large volumes of resources, projections, and complex relationships while maintaining high performance and scalability.

The system may use a graph database to store the projection structure. Graph databases may be particularly well-suited for representing and querying the complex relationships between resources, namespaces, and projections. In some implementations, the system may use a native graph database, such as Neo4j or Amazon Neptune, which may offer optimized performance for traversing relationships and executing graph queries.

In other cases, the system may implement a custom graph structure on top of a distributed key-value store or document database. This approach may allow for fine-tuned control over data distribution and query optimization. For example, the system may use Apache Cassandra or MongoDB as the underlying storage layer, with a custom indexing scheme to efficiently represent and query the projection graph.

Some implementations may employ a hybrid approach, combining multiple database technologies to leverage their respective strengths. For instance, the system may use a relational database for storing structured metadata about resources and projections, while using a graph database for representing and querying the relationships between them.

To improve query performance, the system may implement various caching mechanisms. This may include in-memory caches for frequently accessed projections, resource metadata, and resource content, as well as distributed caches to support high concurrency in multi-user environments. The system may use technologies such as Redis or Memcached for this purpose.

In some cases, the system may employ indexing strategies tailored to common projection queries. This may include creating specialized indexes for efficient lookup of projections by source or target resource ID, namespace, or other attributes. The system may maintain inverted indexes to support full-text search across relationships, resource content, and resource metadata.

For handling large-scale deployments, the system may implement sharding strategies to distribute projection data across multiple nodes. This may involve partitioning the data based on criteria such as namespace, resource type, or a hash of the resource ID. The sharding scheme may be designed to balance query load and minimize cross-shard operations.

The backend may implement a query optimization layer that analyzes incoming queries and determines the most efficient execution plan. This may involve techniques such as query rewriting, join order optimization, and selective denormalization of projection data.

To support real-time updates and notifications, the system may implement an event streaming architecture. This may involve using technologies like Apache Kafka or Amazon Kinesis to propagate projection and permission changes across the system in a scalable and fault-tolerant manner.

In some implementations, the backend may use a distributed processing framework like Apache Spark or Flink to execute complex analytical queries over large projection datasets. This may enable advanced features such as generating aggregate statistics, detecting patterns in projection usage, or performing large-scale graph algorithms.

The system may implement versioning and snapshotting mechanisms to track changes in the projection structure over time. This may involve storing incremental changes or periodic full snapshots of the projection graph, allowing for historical queries and the ability to roll back to previous states.

The system may implement staged queries, wherein a series of stages are specified, along with instructions specifying the routing and propagation of input items and generated items between the stages. Furthermore, queries may be executed with stage queues accepting inputs incrementally. These backend implementations may be used individually or in combination to create a robust and scalable foundation for managing projections and resource relationships in embodiments of the present invention.

### Broadening Language Boilerplate

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention apply tags to resources stored in one or more computer systems, and perform functions including determining whether the target resource of a projection exists and whether conditions for such attachment are satisfied. For example, as described above, embodiments of the present invention distinguish between an attached resource (a projected resource that has been attached to a target resource) and a floating resource (a projected resource that is not attached to a target resource). This ability to project resources and to distinguish between attached resources and floating resources is not only impossible to implement mentally or manually, but is also inherently rooted in computer technology.

In some cases, embodiments of the present invention provide a technological solution for managing distributed resources across multiple resource providers through the use of projections and projection graphs. The system may address technical challenges in organizing and accessing data across disparate systems by implementing a unified framework for resource management. For example, the system may utilize resource identifiers (RIDs) to create associations between resources independently of their resource providers. These associations, called projections, may enable users to organize and access resources in ways that transcend traditional folder-based hierarchies. Projections may span across different resource providers, users, and namespaces, providing a unified view of distributed resources.

In some implementations, the system may integrate diverse resource types and providers into a cohesive framework using projections. This integration may overcome limitations of conventional file systems and folder-based organization methods, which often struggle to provide flexible organization and efficient retrieval capabilities across multiple platforms. Such projections may allow for the representation of complex relationships between resources, enabling sophisticated organization and collaboration scenarios. In some cases, the system may support multiple valid organizational paths for the same resources, providing flexibility in how users can access and manage data across different contexts.

By decoupling the logical organization of resources from their physical storage locations, the system may enable more efficient data management and retrieval. This decoupling may allow users to create logical groupings of resources that span different storage systems or cloud services, addressing challenges faced when trying to organize and access data across various platforms and devices.

In some implementations, the system may provide mechanisms for resolving resource references even when the underlying resources are unavailable or restricted. This capability may enhance system robustness and continuity in distributed environments where resource availability may fluctuate.

The technological solution provided by embodiments of the present invention may improve the efficiency and effectiveness of computer-implemented resource management, particularly in complex, distributed computing environments. By addressing the technical challenges of organizing and accessing data across disparate systems, the invention may offer practical applications in various fields requiring sophisticated data management and collaboration capabilities.

The system may implement a sophisticated permission model using grants that allows fine-grained control over resource visibility and access. This model may enhance computer security and access management in distributed resource environments. Grants may allow for granular control over how projections and resources are accessed, viewed, and manipulated by different clients within various namespaces. By utilizing grants, the system may provide a flexible and powerful way to implement complex access control scenarios that go beyond traditional file system permissions.

The grant system may support various types of permissions, including but not limited to “project” and “view” permissions. These permissions may be mutually exclusive, providing precise control over client actions within a namespace. In some cases, an “admin” permission may also be implemented, enabling certain clients to modify grants for a namespace without necessarily having view or project permissions themselves.

Grants may include scope parameters that define the applicability of permissions. The scope may encompass factors such as specific resource IDs, namespaces, versions, or combinations thereof. This granular scoping may allow for highly customized access control configurations tailored to specific organizational needs.

In some aspects, the system may support conditional grants. These may include time-based conditions, usage-based conditions, content-based conditions, user role-based conditions, or attribute-based conditions. Such conditions may enable dynamic permission management based on various contextual factors, enhancing the system's ability to adapt to changing security requirements.

The permission model may also incorporate a priority system for grants. This may allow for the resolution of conflicting permissions, with higher priority grants taking precedence over lower priority ones. Such a system may enable more nuanced and flexible access control policies.

In some implementations, the system may provide mechanisms for grant expiration and revocation. This may include automatic disabling or removal of grants based on specified conditions, enhancing the system's ability to maintain up-to-date access controls.

The sophisticated permission model may improve computer security by enabling precise control over resource access and visibility. It may reduce the risk of unauthorized access to sensitive resources while still allowing for flexible collaboration scenarios. The fine-grained nature of the permissions may also enhance access management efficiency, allowing system administrators to implement complex access policies with reduced overhead.

By providing these advanced permission capabilities, embodiments of the present invention may offer a technical improvement over conventional access control systems, particularly in distributed and collaborative computing environments. This may result in more secure and efficiently managed resource access across diverse computing platforms and resource providers.

In some implementations, embodiments of the present invention may introduce projection states that determine how projections appear to different users. These projection states may include private, floating, not-visible, and attached states, enabling more nuanced control over resource visibility within the system. The private state may allow users to create personal organizational schemes or work-in-progress associations without affecting the broader resource management landscape. When a projection is in a private state, it may be visible only to its creator, allowing users to experiment with different ways of linking resources or preparing collaborative structures before making them visible to others. The floating state may represent projections that are visible to certain users but not yet fully integrated into the namespace structure. Floating projections may serve as a transitional state, allowing for review or approval processes before projections become more widely accessible. The not-visible state may be used to completely hide projections from users who lack appropriate permissions or are not intended to see certain resource associations. This state may provide an additional layer of access control and information hiding within the system. The attached state may indicate that a projection is fully integrated and visible within a namespace structure. Projections in the attached state may be accessible to users with appropriate permissions, allowing for collaborative work and shared resource organization.

In some aspects, the system may dynamically manage these projection states based on various factors such as user permissions, grant conditions, and system events. The state of a projection may change in response to actions like permission grants, user requests, or automated system processes.

The system may allow for granular control over which users can see projections in different states. For example, namespace owners may be able to see floating projections within their namespace, while other users may only see attached projections. This granular visibility control may enable sophisticated collaboration scenarios while maintaining appropriate access controls.

By implementing these projection states, the system may provide a more flexible and powerful approach to managing resource visibility. Users may be able to create and manage projections with varying levels of visibility and integration, supporting diverse workflows and organizational needs.

The projection state system may also enhance security and privacy within the resource management environment. By providing fine-grained control over projection visibility, the system may help prevent unauthorized access to sensitive resource associations while still enabling efficient collaboration and resource sharing when appropriate. This nuanced approach to projection visibility may improve upon traditional binary access control models, offering a more sophisticated and context-aware method for managing resource relationships and their visibility across different users and scenarios within the distributed resource management system.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention apply tags to resources stored in one or more computer systems, and perform functions including determining whether the target resource of a projection exists and whether conditions for such attachment are satisfied. The system may process and manage large volumes of resources and complex relationships between them at speeds and scales far beyond human cognitive capabilities.

The ability of embodiments of the present invention to dynamically manage projection states across multiple users and namespaces in real-time is inherently tied to computer technology. For example, embodiments of the present invention may instantly update and propagate changes to projection visibility based on complex permission models and user interactions, a task that would be infeasible for a human to perform manually, especially in a distributed environment with multiple resource providers.

In some cases, embodiments of the present invention may execute structured queries across distributed resources, potentially spanning multiple storage systems or cloud services. This querying capability relies on computer processing power to rapidly traverse complex projection graphs, filter results based on permissions, and aggregate data from disparate sources
operations that are impractical to perform manually, particularly at the scale and speed required for effective resource management.

The system's ability to maintain relationships between resources even when they become unavailable or restricted is a feature inherently rooted in computer technology. This involves complex state tracking and resolution mechanisms that operate continuously across distributed systems, a task beyond human cognitive capacity to manage effectively.

Embodiments of the invention may implement automated trigger conditions and expiration conditions for grants and projections. These conditions may be evaluated in real-time based on system events, time factors, or resource states, enabling automated actions that would be impossible for a human to consistently execute, especially in a large-scale distributed environment.

The cyclic projection feature of embodiments of the present invention, which allows for multiple valid organizational paths for the same resources, creates complex graph structures that are difficult for the human mind to conceptualize and navigate without computational assistance. The system's ability to efficiently traverse and query these structures is fundamentally a computer-implemented process.

In some implementations, the system may integrate diverse resource types and providers into a unified management framework, handling various protocols, data formats, and access methods transparently to the user. This level of abstraction and integration across disparate systems is inherently a computer-implemented feature that goes beyond what is practically achievable through manual means.

The sophisticated permission model using grants, with its ability to resolve conflicts, apply conditions, and manage fine-grained access controls across multiple namespaces and users, requires computational power to evaluate and enforce in real-time. The complexity of this model, especially in a dynamic, multi-user environment, makes it impractical to implement without computer assistance.

These features collectively demonstrate that embodiments of the present invention are necessarily rooted in computer technology, providing technological solutions to challenges in distributed resource management that are not practically performed by the human mind.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or grayscale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

What is claimed is:

1. A method for use with projections and projection states, the method performed by at least one computer processor executing computer program instructions stored on at least one non-transitory computer-readable medium,
wherein a permission model specifies “project” and “view” permissions and calculates the projection states of the projections;
wherein each of the projection states calculated by the permission model has permissible values of “private,” “floating,” “attached,” or “not-visible,”
wherein permission granted by the permission model to each of a plurality of clients has permissible values of “project” and “view,”
wherein the plurality of clients can view all “non-private” projections;
wherein, for any private projection created by a first projector into a first namespace:
the private projection appears as “private” to that first projector,
the private projection appears as “not-visible” to owners of that first namespace,
the private projection appears as “not-visible” to clients having “view” permission for that private projection, and
the private projection appears as “not-visible” to clients not having “view” permission for that private projection;
wherein for any non-private projection created by a second projector into a second namespace, when that non-private projection lacks the “project” permission:
the non-private projection appears as “floating” to that second projector,
the non-private projection appears as “floating” to owners of that second namespace,
the non-private projection appears as “not-visible” to clients having “view” permission for that non-private projection, and
the non-private projection appears as “not-visible” to clients not having “view” permission for that non-private projection;
wherein for any non-private projection created by a third projector into a third namespace, when that non-private projection has the “project” permission:
the non-private projection appears as “attached” to that third projector,
the non-private projection appears as “attached” to owners of that third namespace,
the non-private projection appears as “attached” to clients having “view” permission for that non-private projection, and
the non-private projection appears as “not-visible” to clients not having “view” permission for that non-private projection;
the method comprising:
(A) creating, in response to input from a first client, a first projection of a first resource identifier (ID) onto a second resource ID in a first namespace owned by a second client, wherein:
the first projection has, for each of a plurality of clients, a corresponding projection state that indicates whether the projection is in a “private state,” a “floating state,” a “not-visible state,” or an “attached state” for that client;
the first projection creates an association between the first resource ID and the second resource ID independently of resource providers of the first resource ID and the second resource ID;
the first projection has a “private” parameter with a disabled value;
(B) in response to determining that the first client is not marked private and lacks “project” permission for the first projection, setting the projection state of the first projection to indicate the “floating” state for the first client and the second client, wherein in the floating state:
the first projection is visible to the first client as a “floating” projection,
the first projection is visible to all owner clients of the first namespace, including the second client, as a “floating” projection, and
the first projection is not visible to other clients having “view” permission for the projection as a “not-visible” projection;
the first projection is not visible to other clients not having “view” permission for the projection as a “not-visible” projection;
(C) receiving, from the second client, input specifying a grant that provides the “project” permission to the first client for projecting resources into the first namespace; and
(D) in response to receiving the input specifying the grant that provides the “project” permission to the first client, changing the projection state of the first projection from indicating the “floating” state for the first and second clients to indicating the “attached” state for the first and second clients, and all clients of the second namespace having the “view” permission, wherein in the attached state:
the first projection is visible to the first client as an attached projection, and
the first projection is visible to all owner clients of the first namespace, including the second client, as an “attached” projection,
the first projection is visible to other clients having “view” permission for the projection, as an “attached” projection, and
the first projection is not visible to other clients not having “view” permission for the projection, as a “not-visible” projection.

2. The method of claim 1, further comprising:
(E) receiving input specifying setting the “private” parameter of the first projection to the enabled value; and
(F) in response to receiving the input specifying the first projection to have a private parameter with an “enabled” value, updating the first projection to be visible to the first client as a “private” projection, and not-visible to all other clients as a “not-visible” projection, wherein in the private state:
the first projection is visible to the first client as a “private” projection, and
the first projection is not visible to all owner clients of the first namespace, including the second client, as a “not-visible” projection,
the first projection is not visible to other clients having “view” permission for the projection, as a “not-visible” projection, and
the first projection is not visible to other clients not having “view” permission for the projection, as a “not-visible” projection.

3. The method of claim 1, further comprising:
(E) receiving input specifying revoking the “project” permission from first client for the first projection, whereas the first client previously was granted the “project” permission for the first projection; and
(F) in response to receiving the input specifying the grant that revokes the “project” permission from the first client for the first projection, changing the projection state of the first projection to the “floating” state for the first, second client, and owner clients of the first namespace for the first projection, and changing the projection state for other clients having and not having the “view” permission to the “not-visible” state, wherein:
the first projection is visible to the first client as a “floating” projection, and
the first projection is visible to all owner clients of the first namespace, including the second client, as a “floating” projection,
the first projection is not visible to other clients having “view” permission for the projection, as an “not-visible” projection, and
the first projection is not visible to other clients not having “view” permission for the projection, as a “not-visible” projection.

4. The method of claim 1, further comprising:
(E) receiving, from the second client, input creating a grant for the first namespace, wherein the second client is an owner of the first namespace, wherein the grant specifies:
at least one permission selected from project permission and view permission;
a scope indicating the first namespace and at least one grantee;
(F) activating the grant in the computer system, wherein in response to activating the grant, for each client specified as a grantee in the scope:
identifying at least one permission applicable to that client based on the grant; and
resolving projection states for that client in accordance with the at least one permission applicable to that client.

5. The method of claim 1, further comprising:
(E) receiving, from the second client, input creating a grant, wherein the second client is an owner of at least one namespace including the first namespace, wherein the grant specifies:
at least one permission; and
a scope comprising at least one of:
any version of projections,
any namespace owned by the second client,
a specific resource ID across any namespace or version owned by the second client,
a specific combination of namespace and version,
a specific projector client independent of namespace or version, or
a specific target resource ID independent of namespace or version, or
a specific source resource ID independent of namespace or version;
(F) activating the grant in the computer system, wherein in response to activating the grant, for each client specified as a grantee in the scope:
identifying at least one permission applicable to that client based on the grant and the scope; and
resolving projection states for that client in accordance with the at least one permission applicable to that client.

6. The method of claim 5, wherein the grant further specifies a condition set comprising at least one condition for applying the at least one permission, wherein the at least one condition comprises at least one of:
a time-based condition;
a usage-based condition;
a content-based condition;
a user role-based condition; or
an attribute-based condition.

7. The method of claim 1, further comprising:
determining that an entity referenced by a particular resource ID does not exist;
in response to determining that the entity referenced by the particular resource ID does not exist, setting an orphan flag for the particular resource ID to indicate resource non-existence.

8. The method of claim 7, wherein the particular resource ID comprises the first resource ID, and wherein determining that the entity referenced by the particular resource ID does not exist comprises determining that a resource referenced by the first resource ID does not exist.

9. The method of claim 1, further comprising:
projecting the second resource ID onto a third resource ID;
projecting the third resource ID onto the first resource ID, wherein the projection of the third resource ID onto the first resource ID creates a second projection, wherein:
the first projection and the second projection, together with the projection of the first resource ID onto the second resource ID, create a cycle comprising the first resource ID, the second resource ID, and the third resource ID, and
any resource ID in the cycle can function as either a root or a leaf;
calculating a first projection path starting from the first resource ID and ending with the third resource ID as a leaf;
calculating a second projection path starting from the second resource ID and ending with the first resource ID as a leaf; and
calculating a third projection path starting from the third resource ID and ending with the second resource ID as a leaf;
wherein each calculated path represents a valid hierarchical view of the cycle; and
wherein multiple valid paths may exist simultaneously for the same set of projected resources.

10. The method of claim 1, further comprising:
projecting the first resource ID onto a third resource ID, wherein the projection of the first resource ID onto the third resource ID creates a first additional projection;
projecting the third resource ID onto a fourth resource ID, wherein the projection of the third resource ID onto the fourth resource ID creates a second additional projection;
projecting the second resource ID onto the fourth resource ID, wherein the projection of the second resource ID onto the fourth resource ID creates a third additional projection; wherein
calculating a first projection path starting from the first resource ID and ending with the fourth resource ID as a leaf, wherein the first projection path includes the second resource ID as an intermediate node;
calculating a second projection path starting from the first resource ID and ending with the fourth resource ID as a leaf, wherein the second projection path includes the third resource ID as an intermediate node;
wherein multiple valid paths exist simultaneously for the same set of projected resources.

11. The method of claim 1, further comprising:
creating a grant having an “ask” condition for the first namespace;
creating, in response to input from the first client, a second projection of the first resource onto the second resource in the first namespace;
generating a grant token for tracking the second projection's ask request;
in response to creating the second projection:
setting the second projection's projection state for the first client to indicate an ask-init state;
setting the second projection's projection state for any owner client of the second namespace to indicate a not-visible state;
setting the second projection's projection state for any client having view permission for the second projection to indicate the not-visible state;
triggering at least one action in response to setting the second projection's projection state for the first client to indicate the ask-init state;
receiving confirmation of the ask request from the first client;
in response to receiving the confirmation:
setting the second projection's projection state for the first client to indicate an ask-pending state;
setting the second projection's projection state for any owner client of the second namespace to indicate the ask-pending state;
triggering at least one action in response to setting the second projection's projection state for the first client to the ask-pending state;
in response to receiving, from an owner client of the first namespace, an approval response to the ask request:
setting the second projection's projection state for the first client to indicate the attached state;
setting the second projection's projection state for any owner client of the first namespace to indicate the attached state;
setting the second projection's projection state for any client having view permission for the second projection to indicate the attached state;
triggering at least one action in response to setting the second projection's projection state for the first client to indicate the attached state;
in response to receiving a denial-always response:
setting the second projection's projection state for the first client to indicate an ask-denied state;
setting the second projection's projection state for any owner client of the first namespace to indicate the not-visible state;
setting the second projection's projection state for any client having view permission for the second projection to indicate the not-visible state, and
trigger at least one action in response to setting the second projection's projection state for the first client to indicate the ask-denied state;
in response to receiving a denial-once response:
setting the second projection's projection state for the first client to indicate an ask-init state;
setting the second projection's projection state for any owner client of the first namespace to indicate the not-visible state;
setting the second projection's projection state for any client having view permission for the second projection to indicate the not-visible state; and
triggering at least one action in response to setting the second projection's projection state for the first client to indicate the ask-init state.

12. The method of claim 11, further comprising:
in response to setting the second projection's projection state for the first client to indicate the ask-init state:
notifying the first client that the second projection's projection state indicates the ask-init state.

13. The method of claim 11, further comprising:
receiving, from the first client, an indication enabling automatic ask requests for projections by the first client;
receiving, from an owner client of the first namespace, an indication enabling automatic processing of ask requests for the first namespace;
wherein, in response to creating the second projection and determining that both automatic ask requests and automatic processing are enabled:
automatically sending the ask request without requiring explicit confirmation from the first client; and
automatically setting the second projection's projection state for the first client to indicate the ask-pending state without requiring explicit confirmation of the ask request.

14. A system for use with projections and projection states, the system including at least one non-transitory computer-readable medium having computer program instructions stored thereon, the computer program instructions being executable by at least one computer processor to perform a method,
wherein a permission model specifies “project” and “view” permissions and calculates the projection states of the projections;
wherein each of the projection states calculated by the permission model has permissible values of “private,” “floating,” “attached,” or “not-visible,”
wherein permission granted by the permission model to each of a plurality of clients has permissible values of “project” and “view,”
wherein the plurality of clients can view all “non-private” projections;
wherein, for any private projection created by a first projector into a first namespace:
the private projection appears as “private” to that first projector,
the private projection appears as “not-visible” to owners of that first namespace,
the private projection appears as “not-visible” to clients having “view” permission for that private projection, and
the private projection appears as “not-visible” to clients not having “view” permission for that private projection;
wherein for any non-private projection created by a second projector into a second namespace, when that non-private projection lacks the “project” permission:
the non-private projection appears as “floating” to that second projector,
the non-private projection appears as “floating” to owners of that second namespace,
the non-private projection appears as “not-visible” to clients having “view” permission for that non-private projection, and
the non-private projection appears as “not-visible” to clients not having “view” permission for that non-private projection;
wherein for any non-private projection created by a third projector into a third namespace, when that non-private projection has the “project” permission:
the non-private projection appears as “attached” to that third projector,
the non-private projection appears as “attached” to owners of that third namespace,
the non-private projection appears as “attached” to clients having “view” permission for that non-private projection, and
the non-private projection appears as “not-visible” to clients not having “view” permission for that non-private projection;
the method comprising:
(A) creating, in response to input from a first client, a first projection of a first resource identifier (ID) onto a second resource ID in a first namespace owned by a second client, wherein:
the first projection has, for each of a plurality of clients, a corresponding projection state that indicates whether the projection is in a “private state,” a “floating state,” a “not-visible state,” or an “attached state” for that client;
the first projection creates an association between the first resource ID and the second resource ID independently of resource providers of the first resource ID and the second resource ID;
the first projection has a “private” parameter with a disabled value;
(B) in response to determining that the first client is not marked private and lacks “project” permission for the first projection, setting the projection state of the first projection to indicate the “floating” state for the first client and the second client, wherein in the floating state:
the first projection is visible to the first client as a “floating” projection,
the first projection is visible to all owner clients of the first namespace, including the second client, as a “floating” projection, and
the first projection is not visible to other clients having “view” permission for the projection as a “not-visible” projection;
the first projection is not visible to other clients not having “view” permission for the projection as a “not-visible” projection;
(C) receiving, from the second client, input specifying a grant that provides the “project” permission to the first client for projecting resources into the first namespace; and
(D) in response to receiving the input specifying the grant that provides the “project” permission to the first client, changing the projection state of the first projection from indicating the “floating” state for the first and second clients to indicating the “attached” state for the first and second clients, and all clients of the second namespace having the “view” permission, wherein in the attached state:
the first projection is visible to the first client as an attached projection, and
the first projection is visible to all owner clients of the first namespace, including the second client, as an “attached” projection,
the first projection is visible to other clients having “view” permission for the projection, as an “attached” projection, and
the first projection is not visible to other clients not having “view” permission for the projection, as a “not-visible” projection.

15. The system of claim 14, wherein the method further comprises:
(E) receiving input specifying setting the “private” parameter of the first projection to the enabled value; and
(F) in response to receiving the input specifying the first projection to have a private parameter with an “enabled” value, updating the first projection to be visible to the first client as a “private” projection, and not-visible to all other clients as a “not-visible” projection, wherein in the private state:
the first projection is visible to the first client as a “private” projection, and
the first projection is not visible to all owner clients of the first namespace, including the second client, as a “not-visible” projection,
the first projection is not visible to other clients having “view” permission for the projection, as a “not-visible” projection, and
the first projection is not visible to other clients not having “view” permission for the projection, as a “not-visible” projection.

16. The system of claim 14, wherein the method further comprises:
(E) receiving input specifying revoking the “project” permission from first client for the first projection, whereas the first client previously was granted the “project” permission for the first projection; and
(F) in response to receiving the input specifying the grant that revokes the “project” permission from the first client for the first projection, changing the projection state of the first projection to the “floating” state for the first, second client, and owner clients of the first namespace for the first projection, and changing the projection state for other clients having and not having the “view” permission to the “not-visible” state, wherein:
the first projection is visible to the first client as a “floating” projection, and
the first projection is visible to all owner clients of the first namespace, including the second client, as a “floating” projection,
the first projection is not visible to other clients having “view” permission for the projection, as an “not-visible” projection, and
the first projection is not visible to other clients not having “view” permission for the projection, as a “not-visible” projection.

17. The system of claim 14, wherein the method further comprises:
(E) receiving, from the second client, input creating a grant for the first namespace, wherein the second client is an owner of the first namespace, wherein the grant specifies:
at least one permission selected from project permission and view permission;
a scope indicating the first namespace and at least one grantee;
(F) activating the grant in the computer system, wherein in response to activating the grant, for each client specified as a grantee in the scope:
identifying at least one permission applicable to that client based on the grant; and
resolving projection states for that client in accordance with the at least one permission applicable to that client.

18. The system of claim 14, wherein the method further comprises:
(E) receiving, from the second client, input creating a grant, wherein the second client is an owner of at least one namespace including the first namespace, wherein the grant specifies:
at least one permission; and
a scope comprising at least one of:
any version of projections,
any namespace owned by the second client,
a specific resource ID across any namespace or version owned by the second client,
a specific combination of namespace and version,
a specific projector client independent of namespace or version, or
a specific target resource ID independent of namespace or version, or
a specific source resource ID independent of namespace or version;
(F) activating the grant in the computer system, wherein in response to activating the grant, for each client specified as a grantee in the scope:
identifying at least one permission applicable to that client based on the grant and the scope; and
resolving projection states for that client in accordance with the at least one permission applicable to that client.

19. The system of claim 14, wherein the method further comprises:
projecting the second resource ID onto a third resource ID;
projecting the third resource ID onto the first resource ID, wherein the projection of the third resource ID onto the first resource ID creates a second projection, wherein:
the first projection and the second projection, together with the projection of the first resource ID onto the second resource ID, create a cycle comprising the first resource ID, the second resource ID, and the third resource ID, and
any resource ID in the cycle can function as either a root or a leaf;
calculating a first projection path starting from the first resource ID and ending with the third resource ID as a leaf;
calculating a second projection path starting from the second resource ID and ending with the first resource ID as a leaf; and
calculating a third projection path starting from the third resource ID and ending with the second resource ID as a leaf;
wherein each calculated path represents a valid hierarchical view of the cycle; and
wherein multiple valid paths may exist simultaneously for the same set of projected resources.

20. The system of claim 14, wherein the method further comprises:
creating a grant having an “ask” condition for the first namespace;
creating, in response to input from the first client, a second projection of the first resource onto the second resource in the first namespace;
generating a grant token for tracking the second projection's ask request;
in response to creating the second projection:
setting the second projection's projection state for the first client to indicate an ask-init state;
setting the second projection's projection state for any owner client of the second namespace to indicate a not-visible state;
setting the second projection's projection state for any client having view permission for the second projection to indicate the not-visible state;
triggering at least one action in response to setting the second projection's projection state for the first client to indicate the ask-init state;
receiving confirmation of the ask request from the first client;
in response to receiving the confirmation:
setting the second projection's projection state for the first client to indicate an ask-pending state;
setting the second projection's projection state for any owner client of the second namespace to indicate the ask-pending state;
triggering at least one action in response to setting the second projection's projection state for the first client to the ask-pending state;
in response to receiving, from an owner client of the first namespace, an approval response to the ask request:
setting the second projection's projection state for the first client to indicate the attached state;
setting the second projection's projection state for any owner client of the first namespace to indicate the attached state;
setting the second projection's projection state for any client having view permission for the second projection to indicate the attached state;
triggering at least one action in response to setting the second projection's projection state for the first client to indicate the attached state;
in response to receiving a denial-always response:
setting the second projection's projection state for the first client to indicate an ask-denied state;
setting the second projection's projection state for any owner client of the first namespace to indicate the not-visible state;
setting the second projection's projection state for any client having view permission for the second projection to indicate the not-visible state, and
trigger at least one action in response to setting the second projection's projection state for the first client to indicate the ask-denied state;
in response to receiving a denial-once response:
setting the second projection's projection state for the first client to indicate an ask-init state;
setting the second projection's projection state for any owner client of the first namespace to indicate the not-visible state;
setting the second projection's projection state for any client having view permission for the second projection to indicate the not-visible state; and
triggering at least one action in response to setting the second projection's projection state for the first client to indicate the ask-init state.
